(19) United States
(12) Patent Application Publication
(10) Pub. No.: US 2012/0274846 A1
(43) Pub. Date: Nov. 1, 2012

(54) SECONDARY CONTENT PROVISION SYSTEM AND METHOD

(76) Inventors: Hiroaki Kimura, Saitama (JP); Yukiko Habu, Saitama (JP)

(21) Appl. No.: 13/511,833

(22) PCT Filed: Nov. 11, 2010
(86) PCT No.: PCT/JP2010/070102

§ 371 Date: May 24, 2012

(30) Foreign Application Priority Data
Nov. 25, 2009 (JP) 2009-267394
Oct. 15, 2010 (JP) 2010-232913

(51) Int. Cl. H04N 7/01; G06K 9/62

(52) U.S. Cl. 348/441; 382/224; 348/E07.003

(57) ABSTRACT

Disclosed is a secondary content provision system and method capable of automated creation and distribution of secondary content, such as digital albums, that offer high levels of satisfaction to users, with little inconvenience. After images captured by a user have been divided into segments, the image characteristic quantity thereof is compared with a dictionary, metadata assigned thereto, and stored as primary content. Secondary content is generated with a secondary content creation unit, selecting primary content based on metadata designated in a story template as raw images, and distributing same to the user. If a request for correction is made, the user will initiate the correction by selecting a replacement image from the primary content list. The correction information will also be used in dictionary updates, etc.

### TECHNICAL FIELD

The present invention relates to a secondary content provision system and a method, and more particularly, to a system and a method, which are capable of automatically creating a secondary content such as a digital album using a primary content in which metadata is automatically assigned to each video imaged and accumulated by a user as a material and allowing the user to perform feed-back correction on the content of the secondary content.

### BACKGROUND ART

Patent Literature 1 below discloses the following technique. In order to easily create a digital album with which images of an image data group assigned with metadata in advance can be arranged and viewed, template groups for creating the digital album are prepared such that image data is appended in association with various scenarios such as a sports day or a wedding ceremony. A keyword assigned a priority order is set to each template. Matching analysis of metadata of image data and a keyword of each template is performed, and image data is appended to a template having a keyword with a high priority order. As a result, particularly, an image data group which has been neither classified nor arranged is arranged as a digital album appended to a template suitable for the content.

Patent Literature 2 below discloses the following technique. In order to create moving image data which is obtained by adding rendering such as music or an effect to an image material to which metadata is assigned in advance, template files in which metadata for deciding music or an effect to be used and an image which is to be inserted into a material frame and then used are defined according to various themes are prepared, and a moving image is created using the template files.

Further, Patent Literature 3 below discloses the following technique. In order to create an album configured with image data suitable for a desired story using image data accumulated by a user without any special classification, an album is created by performing search and classification of image data using information such as a creation date and time, place, which are assigned to image data at the time of imaging or the like in advance, or a person included in image data determined based on a sound.

Furthermore, Patent Literature 4 below discloses the following technique. In order to automatically create an album from a moving image acquired from a monitoring camera or the like with small time and effort to edit, an album is created such that a person captured in a moving image is discriminated, moving images in which the discriminated person is captured are extracted from among acquired moving images, and the extracted moving images are connected with each other in order.

### CITATION LIST

### Patent Literature

Patent Literature 1: Japanese Patent Application Laid-Open No. 2002-49907

Patent Literature 2: Japanese Patent Application Laid-Open

No. 2009-55152

Patent Literature 3: Japanese Patent Application Laid-Open No. 2005-107867

Patent Literature 4: Japanese Patent Application Laid-Open No. 2009-88687

### SUMMARY OF INVENTION

### Technical Problem

However, in the techniques disclosed in Patent Literatures 1 and 2, there is a problem in that the user needs to assign metadata to an image or a moving image of a material by himself/herself, and so a heavy burden is placed on the user when there are a lot of material videos.

Further, in the techniques disclosed in Patent Literatures 3 and 4, some metadata can be automatically assigned to an image or a moving image of a material. However, there is a problem in that a video in which automatic allocation has been erroneously performed is not used in creating an album even though the user regards the video as an optimum video.

In order to solve the above problems, an object of the present invention is to provide a secondary content provision system and a method, which are capable of automatically creating and delivering a secondary content, such as a digital album, in which the user's burden is small and the user's satisfaction level is high.

### Solution to Problem

To achieve the object, the present invention is characterized in comprising: a video standard converting unit that converts a video content including a still image uploaded via a network into a video section of a predetermined video standard; a classification/detection category assigning unit that automatically assigns a classification/detection category to said video section converted by said video standard converting unit; a metadata creating unit that creates metadata including said classification/detection category; a primary content storing unit that stores a video file of said video section in association with said metadata as a primary content; a secondary content creating unit that automatically creates a secondary content by selecting said video file associated with said metadata from said primary content storing unit based on said metadata and adding a predetermined edit to said selected video file; a transmitting unit that transmits said secondary content and correction candidate information related to said secondary content; and a feed-back processing unit that receives and processes correction feed-back information related to said secondary content, wherein said feed-back processing unit requests at least one of said classification/detection category assigning unit and said metadata creating unit to perform an update process according to content of said correction feed-back information.

To achieve the object, the present invention is characterized in comprising: a video standard converting unit that converts a video content uploaded via a network into a predetermined video standard; a video dividing unit that divides said video content converted by said video standard converting unit into a plurality of video sections having a relevant content as one video section; a classification/detection category assigning unit that automatically assigns a classification/detection category to said video section divided by said dividing unit; a metadata creating unit that creates metadata including said classification/detection category; a primary content storing unit that stores a video file of said video section in association with said metadata as a primary content; a secondary content creating unit that automatically creates a secondary content by selecting said video file associated with said metadata from said primary content storing unit based on said metadata and adding a predetermined edit to said selected video file; a transmitting unit that transmits said secondary content and correction candidate information related to said secondary content; and a feed-back processing unit that receives and processes said correction feed-back information related to said secondary content, wherein said feed-back processing unit requests at least one of said video dividing unit, said classification/detection category assigning unit, and said metadata creating unit to perform an update process according to content of said correction feed-back information.

### Advantageous Effects of Invention

According to the present invention, a primary content in which a video captured and uploaded by the user is automatically assigned with metadata by a system is created. By adding a predetermined edit using the primary content as a material, a secondary content with a viewing value is created and delivered. Thus, the user can enjoy viewing the secondary content, and even when the secondary content is desired to be corrected, the user can transmit feed-back information to the system.

The feed-back information is used for an update process of a function of assigning metadata to the primary content, and so a performance of the function can be improved by learning. Further, a video feature quantity database is divided into a general database and an individual database, and so an appropriate database can be used when metadata is assigned. Further, a secondary content of a story based on whose face is shown in a video is created using a video supplied and accumulated by the user, and so the user can enjoy a secondary content with a high viewing value.

Further, a secondary content of a story based on the type of a face expression shown in a video is created using a video accumulated by the user, and so the user can enjoy a secondary content with a high viewing value. Further, the user can receive a correction candidate video list of a correction desired location of a secondary content and so can easily correct the secondary content only by selecting from the list. Correction information by the user improves a performance of a metadata assigning function as feed-back information. As a result, when video selection is made by the same story template, a pre-corrected primary content is hardly selected, and a post-corrected and newly selected primary content is easily selected. Thus, the secondary content creating function after correction feedback can be learned and updated to be more suitable for the user. Further, the user can change metadata of the story template and so can also enjoy a secondary content obtained by arranging a viewed secondary content.

### BRIEF DESCRIPTION OF DRAWINGS

FIG. 1 is a block diagram illustrating an example of a network environment in which the present invention is implemented.

FIG. 2 is a block diagram illustrating a configuration of a main portion of the present invention.

FIG. 3 is a block diagram illustrating a configuration when e-mail delivery is used according to a first embodiment of the present invention.

FIG. 4 is a block diagram illustrating a configuration when VoD delivery is used according to a second embodiment of the present invention.

FIG. 5 is a conceptual diagram illustrating that a feature quantity database includes an individual database of each user in addition to a general database.

FIG. 6 is a flowchart for describing a process between a video section dividing unit and a metadata creating unit of FIGS. 3 and 4.

FIG. 7 is a diagram illustrating an example in which a classification/detection category, a conformity degree numerical value, coordinates of a part present in a video, and the like, which are acquired at FIG. 6, are listed.

FIG. 8 is a conceptual diagram illustrating a result of an individual database is prioritized over a result of a general database in step S3 of FIG. 6.

FIG. 9 is a conceptual diagram illustrating a work screen that allows a user to register face information to an individual database.

FIG. 10 is a conceptual diagram illustrating a primary content created from a section video.

FIG. 11 is a flowchart illustrating the flow for creating a secondary content through an instruction of a schedule managing unit.

FIG. 11A is a flowchart illustrating the flow in which a metadata comparing/selecting unit prepares a primary content selection candidate or the like as a list in advance.

FIG. 11B is a flowchart illustrating the flow in which a secondary content based on a list previously prepared in FIG. 11A is created according to an instruction of a schedule managing unit.

FIG. 12 is a flowchart illustrating the flow for creating a secondary content according to a user's instruction.

FIG. 13 is a conceptual diagram illustrating a general configuration of a story template.

FIG. 14 is a diagram illustrating examples of items which can be used in connection with face detection, face recognition, and face expression recognition as an example of metadata items for primary content selection in a story template.

FIG. 15 is a diagram illustrating examples of items which can be used in connection with scene recognition as an example of metadata items for primary content selection in a story template.

FIG. 16A is a conceptual diagram illustrating an example of a secondary content created by selecting a primary content according to a story template.

FIG. 16B is a conceptual diagram illustrating an example of a secondary content created by selecting a primary content according to a story template.

FIG. 16C is a diagram illustrating an example of a story template for creating secondary contents illustrated in FIGS. 16A and 16B.

FIG. 16D is a diagram partially illustrating a derivation scene of a scene 3 of FIG. 16B.

FIG. 17 is a flowchart illustrating the flow for performing a secondary content correcting/re-creating process by a user and an update process of a primary content creating function using correction information.

FIG. 18 is a conceptual diagram illustrating an example of a scene before and after correction when a user corrects a video file used in a scene automatically created by a system through a process of FIG. 17.

FIG. 19 is a conceptual diagram illustrating an example in which a metadata conformity degree related to a scene is updated in video files before and after correction replacement in FIG. 18.

FIG. 20 is a conceptual diagram illustrating an e-mail transmitted to a user side and an example of a reply e-mail in case of using e-mail support in a process of FIG. 17.

FIG. 21 is a flowchart illustrating the flow of a feedback process according to an embodiment different from the flow of FIG. 17.

FIG. 22 is a block diagram illustrating a configuration of a main portion of the present invention according to an embodiment in which a video input is limited to a still image.

### DESCRIPTION OF EMBODIMENTS

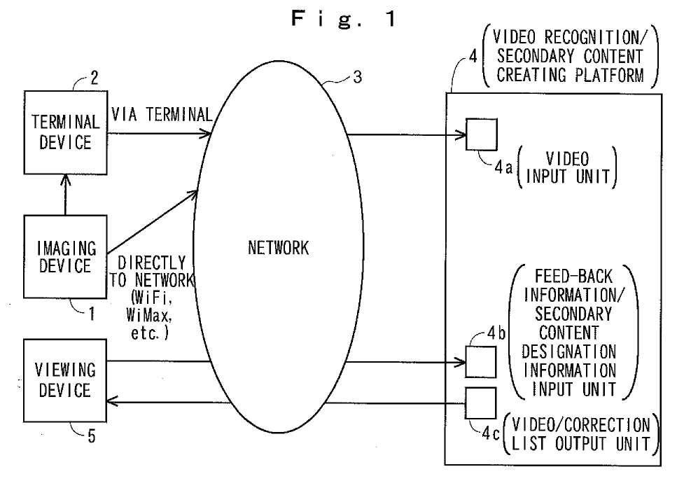

Hereinafter, the present invention will be described in detail with reference to the accompanying drawings. FIG. 1 illustrates an example of a network environment in which the present invention is implemented. First, a description will be made in connection with FIG. 1.

An imaging device 1 includes a video camera, a digital camera, or the like. A video content of a user or the like captured by the imaging device 1 is transferred to a network 3 such as the Internet via a terminal device 2 such as a personal computer (PC) or directly by WiFi, WiMax, or the like, together with management/recognition information such as a user ID and a password necessary for the user to use a video recognition/secondary content creating platform 4. The video content transferred to the network 3 is input to the video recognition/secondary content creating platform 4 (secondary content provision system 4) which is a server through a video input unit 4a. A configuration of the video recognition/secondary content creating platform 4 will be described in detail later. Schematically, the video recognition/secondary content creating platform 4 includes a function of dividing the video content received from the video input unit 4a into video sections, a function of creating a primary content by creating metadata including video classification/detection information and assigning the metadata to each video section, a dictionary function referred to when the metadata is created and assigned, a function of creating a secondary content including the video section and the metadata associated with the video section, a function for creating a user's ID and a password and associating them with the primary content and the secondary content, a function of dealing with feed-back information such, as the user's content correction request on the secondary content, and the like

For example, a camera included in a portable device 2 may be used as the imaging device 1. In this case, for example, a portable terminal (a portable telephone, a smart phone, or the like) has functions of both the imaging device 1 and the portable device 2.

A video may be input to the platform 4 via another system site such as a blog page or a social networking service (SNS) In this case, the user inputs a video to another system site present on the network 3 in advance using the imaging device 1, the terminal device 2, or the like. Then, the user logs in another system site in which his/her video is stored, and inputs the video to the platform 4, for example, by permitting the video to be output to the platform 4.

The video recognition/secondary content creating platform 4 creates a secondary content when a given time comes by a schedule management function which will be described later, when the user's request is received, or the like. The secondary content is automatically created by sequentially selecting primary contents as a construction material using a conformity degree of metadata and incorporating the selected primary contents using a predetermined story template including an array of metadata associated with a story, a scene, or the like. The secondary content is supplied to each user through a video/correction list output unit 4c. The secondary content is supplied to the user in various ways using an e-mail through the network 3 or a video on demand (VoD) infrastructure network, or the like. The user views the secondary content through a viewing device 5 such as a portable terminal, a PC, or a VoD viewing device.

At this time, when the user determines that the primary content in use is inappropriate to a story of the secondary content or the like or goes against the user's preference, the user can transmit a correction request to the video recognition/secondary content creating platform 4 as feed-back information using the viewing device 5 in use. The video recognition/secondary content creating platform 4 receives a correction request through a feed-back information/secondary content designation information input unit 4b, performs an update process on the primary content creating function using information of the correction request, and recreates a secondary content according to the correction request. Further, the user can select a desired secondary content including the recreated secondary content at a desired time and transmit a viewing request, similarly to a well-known VoD viewing form.

Further, a digital photo frame may be used as the viewing device 5. When the digital photo frame is used as the viewing device 5, the digital photo frame may perform only a function of receiving a secondary content and then allowing the user to view the secondary content. The secondary content request transmission function and the feed-back transmission function of the viewing device 5 may be performed by the portable terminal or the like instead of the digital photo frame.

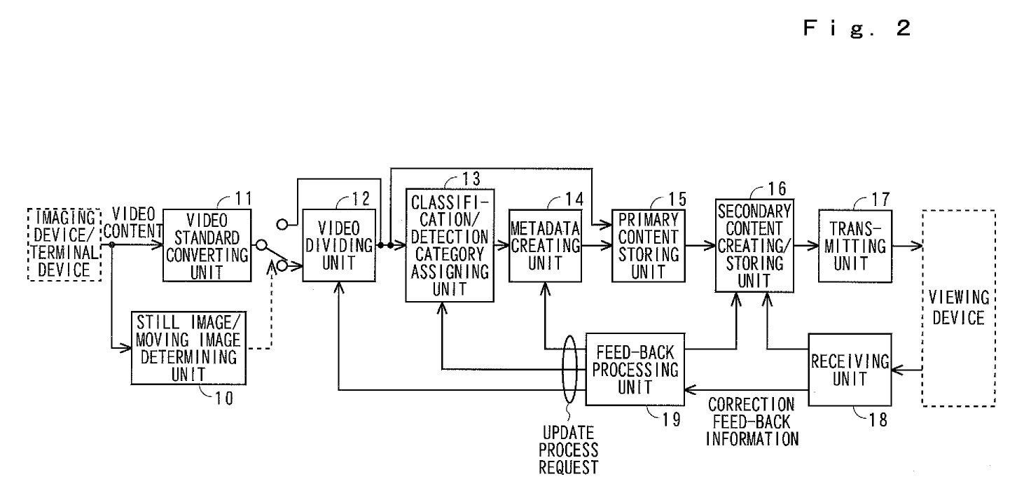

Next, a main portion of a configuration of the video recognition/secondary content creating platform 4 (secondary content provision system 4) will be described with reference to FIG. 2.

The video recognition/secondary content creating platform 4 mainly includes a still image/moving image determining unit 10 that determines whether a video content uploaded together with the recognition information such as the user ID and the password from the user's imaging device or terminal device via the network is a still image or a moving image, a video standard converting unit 11 that converts the video content into a predetermined video standard, a video dividing unit 12 that divides the video content converted by the video standard converting unit 11 into a plurality of video sections in which a relevant content is set as one video section, a classification/detection category assigning unit 13 that automatically assigns a classification/detection category to the video section divided by the video dividing unit 12, a metadata creating unit 14 that creates metadata including the classification/detection category, a primary content storing unit 15 that stores a video section file of the video content in association with the metadata as a primary content, a secondary content creating/storing unit 16 that automatically creates a secondary content using the primary content, a transmitting unit 17 that transmits the secondary content and a correction candidate list to the user as the correction candidate information when the user's correction request are received, a receiving unit 18 that receives correction feed-back information or viewing request information from the user, and a feed-back processing unit 19 that processes the received correction feed-back information.

The video standard converting unit 11 is connected to the video dividing unit 12 when the still image/moving image determining unit 10 determines that a video content is a moving image. However, the video standard converting unit 11 is connected to the classification/detection category assigning unit 13 while bypassing the video dividing unit 12 when the still image/moving image determining unit 10 determines that a video content is a still image. Thus, a video section or a section video divided by the video dividing unit 12 may be regarded as including a case of a still image bypassing the video dividing unit 12 as well as a case of a moving image and may be subjected to processing of the classification/detection category assigning unit 13 and subsequent processing.

The video section and the section video are terms having the same meaning. However, the video section is mainly used in a stage before section division is made, and the section video is mainly used in a stage after section division is made (including a case of a still image that needs not be subjected to the division process).

When the correction request is received as the feed-back information, the feed-back processing unit 19 performs authentication on the user of the transmission source using the user TD or the like, and then causes the secondary content creating/storing unit 16 to create a primary content list including correction candidates at a correction request location, that is, to create correction candidate information. Then, the feed-back processing unit 19 transmits the correction candidate information to the user, and the user transmits a concrete instruction of correction content, for example, by selecting an optimum candidate. Upon receiving the concrete instruction of correction content as correction feed-back information from the user, the feed-back processing unit 19 causes the secondary content creating/storing unit 16 to recreate a secondary content in which the correction content is reflected, and then transmits the recreated secondary content to the user so that the user can view or check the secondary content. Further, the feed-back processing unit 19 requests the video dividing unit 12, the classification/detection category assigning unit 13, and the metadata creating unit 14 to perform the update process based on the correction content.

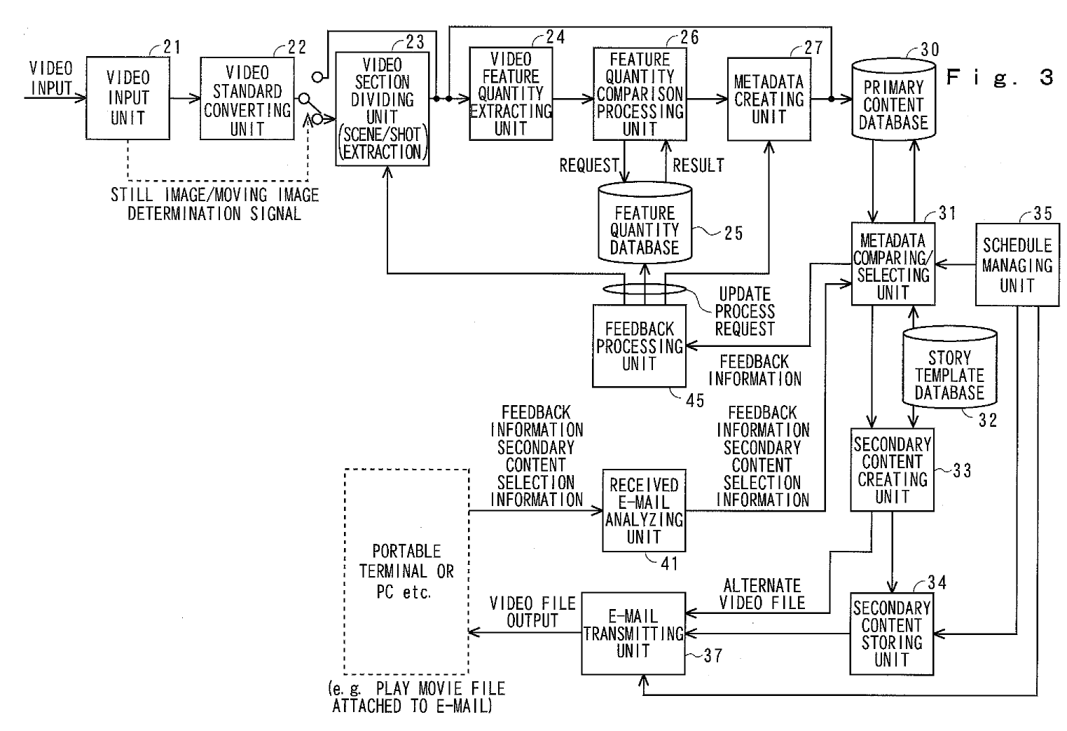

Next, the details of the configuration of the video recognition/secondary content creating platform 4 will be described with reference to FIG. 3 in connection with an example in which e-mail delivery is used in the transmitting unit 17 and the feed-back processing unit 19.

First, a configuration and an operation corresponding to a stage until a section video which is a unit for creating a primary content is prepared are as follows.

As illustrated in FIG. 3, the video recognition/secondary content creating platform 4 includes a video input unit 21 that receives a video content transmitted together with the user authentication information via the network 3, a video standard converting unit 22 that converts, for example, a video of a DV format or a JPEG vide of a still image into an MPEG2 or uncompressed video, and a video section dividing unit 23 that divides the converted video into section videos such as scenes or shots in which a series of relevant contents are consecutive. Upon receiving the video content, the video input unit 21 determines whether the video content is a still image or a moving image. Then, the video input unit 21 performs control based on a determination signal such that the video standard converting unit 22 is connected to the video section dividing unit 23 or the video standard converting unit 22 bypasses the video section dividing unit 23 and is connected to a video feature quantity extracting unit 24. Since the still image needs not be divided into section videos, the video section dividing unit 23 is bypassed, and so the still image becomes the section video “as is”.

The video section dividing unit 23 corresponds to the video dividing unit 12.

Further, a configuration and an operation corresponding to a stage until a primary content is created based on the section video are as follows.

That is, the video recognition/secondary content creating platform 4 includes the video feature quantity extracting unit 24 that extracts a feature quantity from the divided section video, a feature quantity database (or a feature quantity DB) 25 that stores correspondence data between the video feature quantity and video classification/detection information (hereinafter, referred to as a “classification/detection category”, and it is assumed that the classification/detection category further includes conformity degree and a conformity degree numerical value which will be described later) and has a dictionary function in video classification/detection, a feature quantity comparison processing unit 26 that compares the video feature quantity extracted by the video feature quantity extracting unit 24 with dictionary data of the feature quantity database 25, a metadata. creating unit 27 that creates metadata including the classification/detection category suitable for the video feature quantity acquired by the comparison process by the feature quantity comparison processing unit 26, the conformity degree on the video feature quantity of the classification/detection category, the user ID of the user who has uploaded the corresponding video, and the like, and a primary content database 30 that stores and accumulates the metadata and the video file of the divided section video corresponding to the metadata in association with each other as the primary content. The classification/detection category assigning unit 13 corresponds to the video feature quantity extracting unit 24, the feature quantity database 25, and the feature quantity comparison processing unit 26. The feature quantity database 25 is a knowledge-based database using a neural network or the like. The feature quantity database 25 may be a database that can assign the classification/detection category and can be learned from feedback from the user.

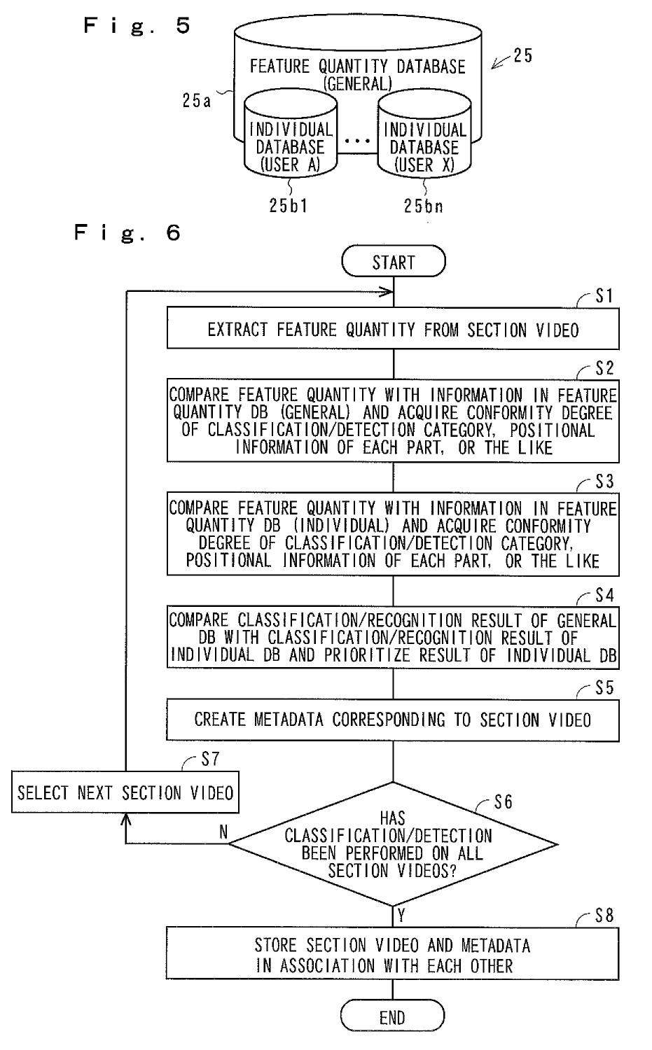

Here, the feature quantity database 25 includes individual databases (or individual DBs) 25b1 to 25bn of users in addition to the general database (or general DB) 25a as illustrated in FIG. 5. The individual databases 25b1 to 25bn stores recognition data specific to the user such as face recognition data of the user family to be linked with a name. The individual database of each user is referred to and used using user authentication information. The general database 25a stores general video feature quantities, for example, general event recognition data such as a baby, crawling, walking, playing in the water, a birthday, a day care center, a sports day, and a theme park, and the event recognition data is commonly referred to and used by all users. Similarly to that the feature quantity database 25 are not only commonly used by all users but also individually used by each user using the user authentication information, contents discriminated according to each user are stored even in the primary content database 30 and the secondary content storing unit 34 in which contents are accumulated and stored by processing using the feature quantity database 25, and processing discriminated according to each user is performed even in other processing as necessary even though not explicitly specified.

The present invention is described in connection with an embodiment in which in the feature quantity database 25, a general database and a database of each user are discriminated from each other, and users are discriminated even in other processing. However, as another embodiment, only the general database may be used without providing the individual database. In this case, data corresponding to individuals are stored in the general database and applied in a variety of processing. Further, in this case, in a variety of processing, a parameter specific to each user is not used, processing common to all users is performed.

A configuration and an operation corresponding to a stage until a secondary content is created from a primary content in FIG. 3 are as follows.

The video recognition/secondary content creating platform 4 includes a metadata comparing/selecting unit 31 that compares metadata of a primary content with metadata information of a story template (which will be described later) in a story template database 32 according to an instruction from the schedule managing unit 35 or feed-back information/secondary content designation information from the user, automatically selects a primary content appropriate as a material of a secondary content or a secondary content correction candidate from the primary content database 30 in descending order of a conformity degree obtained by the comparing process, and transmits the selection result to a secondary content creating unit 33, the secondary content creating unit 33 that creates a secondary content such as a slide show or an album for a PC by sequentially arranging the selected primary contents according to the story template in a frame provided by the story template, and creates correction candidate information of a secondary content as information transmitted to the user based on correction confirmation information for confirming whether or not a portion for which the user requests feedback correction is present in a secondary content and feedback correction request, the secondary content storing unit 34 that stores the created secondary content, and the story template database 32 that stores various story templates prepared in advance for creation of the secondary content or creation of correction candidate information of a secondary content or the like.

A configuration and an operation for automatically managing a schedule of matters such as creation of a primary content, creation of a secondary content, transmission of a secondary content to the user, or various contacts are as follows.

The video recognition/secondary content creating platform 4 includes the schedule managing unit 35. The schedule managing unit 35 has a function of instructing the metadata comparing/selecting unit 31 to select primary content appropriate to a predetermined story template of the story template database 32 from among the primary contents of the primary content database 30 at a predetermined first time as a secondary content creation management function. The schedule managing unit 35 has a function of causing the secondary content creating unit 33 to create a secondary content based on the primary content and causing the created secondary content to be stored in the secondary content storing unit 34. The schedule managing unit 35 has a function of reading the created and stored secondary content from the secondary content storing unit 34 and transmitting the read secondary content to an e-mail transmitting unit 37 at a predetermined second time as a user transmission management function of the secondary content. Further, the schedule managing unit 35 also has a function of attaching the secondary content to an e-mail or the like through the e-mail transmitting unit 37, and attaching and transmitting a replyable correction location instruction list or the like when the user determines that creation of the secondary content is inappropriate.

A configuration as an interface unit for performing exchange related to viewing and correction of a secondary content with the user and the flow of a correction feedback process performed through this configuration are as follows. The feedback from the user includes transmission of correction request information for transmitting a location desired to be corrected in a viewed secondary content to the system as a first step and transmission of correction decision information for deciding a video used for correction from an alternate video list of a correction location replied from the system and transmitting the decided video as a second step.

The video recognition/secondary content creating platform 4 further includes the e-mail transmitting unit 37 that e-mail-transmits the secondary content, the correction candidate list, or the like to the portable terminal or PC viewed by the user and that corresponds to the video/correction list output unit 4c of FIG. 1, and a received e-mail analyzing unit 41 that corresponds to the feed-back information/secondary content designation information input unit 4b of FIG. 1.

When the correction request information for transmitting a location desired to be corrected in the secondary content is received as the first step feed-back information from the user, the received e-mail analyzing unit 41 transmits information of a correction target location to the metadata comparing/selecting unit 31. Further, the metadata comparing/selecting unit 31 reads a correction target location frame of the story template, selects a primary content candidate which is likely to be an exchange target for a primary content for which the correction request is received by comparing a conformity degree order of the metadata designated in the frame with the conformity degree order with the metadata of the primary content, and transmitting the selected primary content candidate to the secondary content creating unit 33 as the correction candidate information. The secondary content creating unit 33 that has received the exchange target primary content candidate transmits a list of the exchange target primary content candidates to the e-mail transmitting unit 37 or processes it at the corresponding location of the corrected secondary content and then transmits the processing result to the e-mail transmitting unit 37. Thus, the user receives the correction candidate list through the e-mail from the e-mail transmitting unit 37.

The user decides a primary content to be used for correction from the correction candidate list and transmits the correction decision information as the second step feed-back information. The received e-mail analyzing unit 41 transfers the correction decision information to the metadata comparing/selecting unit 31 again. The metadata comparing/selecting unit 31 transmits information of a non-corrected primary content and a corrected primary content and metadata application information of the frame of the secondary content in which the primary content is used as a material to the feed-back processing unit 45. The feed-back processing unit 45 requests the video section dividing unit 23, the feature quantity database 25, and the metadata creating unit 27 to perform the update process as a learning function in order to increase a possibility capable of obtaining the corrected result using the transmitted information from the beginning. Here, when the update process is applied to the feature quantity database 25 as the learning function, the database of the feature quantity database 25 is corrected, and update correction processes discriminated by the general database and the individual database are performed. The metadata comparing/selecting unit 31 transmits the feed-back information to the feed-back processing unit 45 to perform the update process, and requests the secondary content creating unit 33, the secondary content storing unit 34, and the e-mail transmitting unit 37 to perform processing in which correction is reflected so that the corrected secondary content can be supplied to the user again.

Further, when correction is not to be made, the user preferably gives an instruction representing the fact.

The flow when the secondary content viewing request or a secondary content creation request of a desired condition from the user is received is as follows. p The video recognition/secondary content creating platform 4 receives secondary content designation information transmitted from the user through the received e-mail analyzing unit 41. The secondary content designation information includes designation information of a story template stored in the story template database 32 or designation, confinement, and change of metadata used in the designated story template in addition to the designation information of the story template. The received e-mail analyzing unit 41 transmits the secondary content designation information to the metadata comparing/selecting unit 31. At this time, the same processing as in the secondary content creation management function and the secondary content user transmission management function of the schedule managing unit 35 described above is performed according to the instruction of the secondary content designation information. Thus, the secondary content is created according to the secondary content designation information and then transmitted to the user. Further, when the secondary content designation information is transmitted, creation and transmission of the secondary content according to the secondary content designation information may not be performed at a predetermined time of the schedule managing unit 35 but instead may be performed immediately after transmission of the secondary content designation information.

In this case, the user can view the requested secondary content prepared and transmitted immediately after transmission of the secondary content request without waiting for creation and transmission of the secondary content by the secondary content creation/transmission management function.

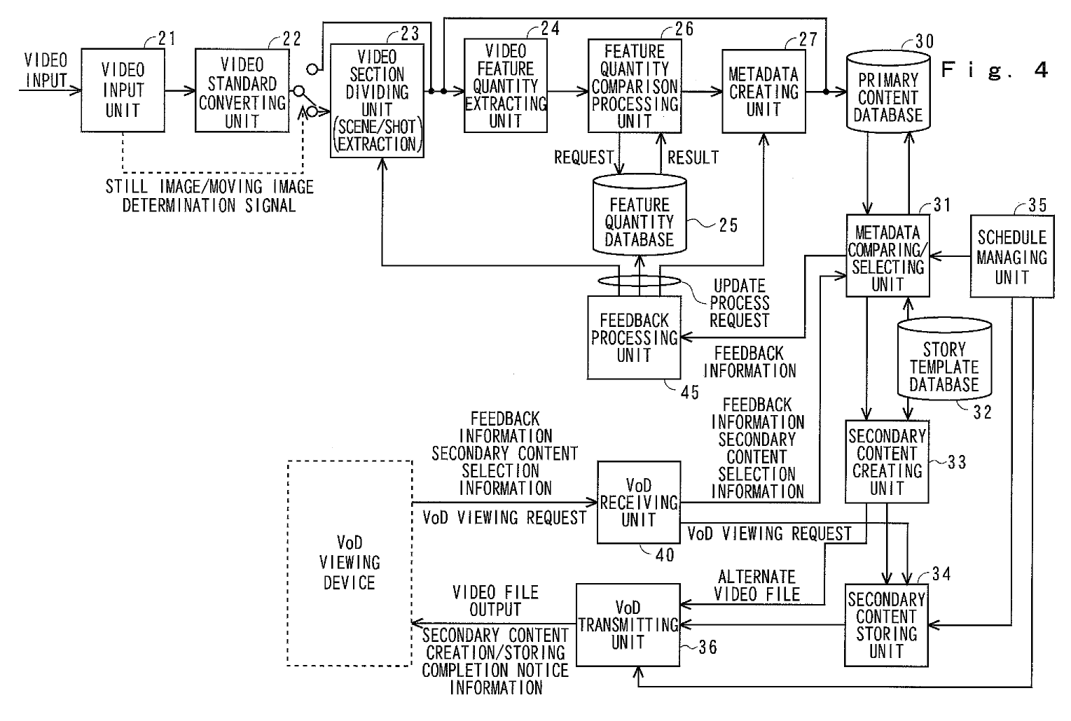

The video recognition/secondary content creating platform 4 has been described above with reference to FIG. 3 in connection with the example in which the e-mail delivery is used in the transmitting unit 17 and the feed-back processing unit 19. However, an example in which video on demand delivery (VoD delivery) is used in the transmitting unit 17 and the feed-back processing unit 19 will be described with reference to FIG. 4 focusing on different points.

A process and the flow to the primary content database 30 from a video input by the user's video content upload in FIG. 4 are the same as at the time of e-mail delivery. As a secondary content creation management function similar to the case of e-mail delivery, the schedule managing unit 35 gives an instruction to the metadata comparing/selecting unit 31 at a predetermined time, causes the metadata comparing/selecting unit 31 to read the story template of the story template database 32 and to select a material of the primary content database 30 from the metadata conformity degree. Further, the schedule managing unit 35 causes the secondary content creating unit 33 to create the secondary content using the selection result and stores the created the secondary content in the secondary content storing unit 34. Unlike the case of the e-mail delivery, the schedule managing unit 35 does not have the user transmission management function of the secondary content, and notifies the user of secondary content creation completion during the flow of the process related to the secondary content creation management function, which will be described later. In other words, when the secondary content storing unit 34 completely stores the secondary content by the secondary content creation management function, the VoD transmitting unit 36 is instructed to transmit only a content completion notice e-mail to the VoD viewing device viewed by the user without transmitting the content body unlike the case of the e-mail delivery. Upon receiving the content completion notice e-mail, the user logs in the site and outputs a VoD viewing request to a VoD receiving unit 40. The VoD receiving unit 40 transmits the secondary content designated in the secondary content storing unit 34 to the user side, and the user views the corresponding content.

Even in FIG. 4, the flow or the process of the feed-back information when there is a correction request on a secondary content viewed by the user and the flow or the process of the secondary content designation information when the user desires are almost the same as at the time of e-mail delivery. In the following, in the video recognition/secondary content creating platform 4, operations of respective portions of the present invention will be described under the assumption that they can be commonly applied when either e-mail delivery or VoD delivery is used in the transmitting unit 17 and the feed-back processing unit 19, that is, to both of the cases of FIGS. 3 and 4 unless otherwise specified.

Further, in the present invention, the VoD delivery illustrated in FIG. 4 include not only a delivery form in which a dedicated set top box (STB) is used in performing requesting and viewing but also a delivery form in which a general PC terminal, a portable terminal, or the like is used in accessing a VoD delivery web site and in performing requesting and viewing. In other words, the VoD viewing device of FIG. 4 may be a dedicated VoD viewing device or a general terminal that can access a web such as a PC terminal or a portable terminal according to various use forms.

The details of an operation of the video section dividing unit 23 are as follows.

As the process in the video section dividing unit 23, generally, when a video change amount between frames of a video content is a predetermined threshold value or more in time, the frame is set as a separation screen (or a cut screen or a scene change screen) of a section video, and a video between the separation screens of the section videos is output to the video feature quantity extracting unit 24. For example, the video section dividing unit 23 can perform division into a section video using well-known techniques disclosed in “Video Cut Point Detection Using Filter”, institute of electronics, information, and communication engineers, fall conference, D-264 (1993), “Cut Detection from Compressed Video Data Using Interframe Luminance Difference and Chrominance Correlation”, institute of electronics, information, and communication engineers, fall conference, D-501 (1994), and JP-A Nos. 07-059108 and 09-083864. The video section dividing unit 23 can perform the update process by correcting the threshold value, based on feed-back information from the user. A “frame” referred to as a screen for separating a video in the video section dividing unit 23 is different from a “frame” in a story template which will be described later.

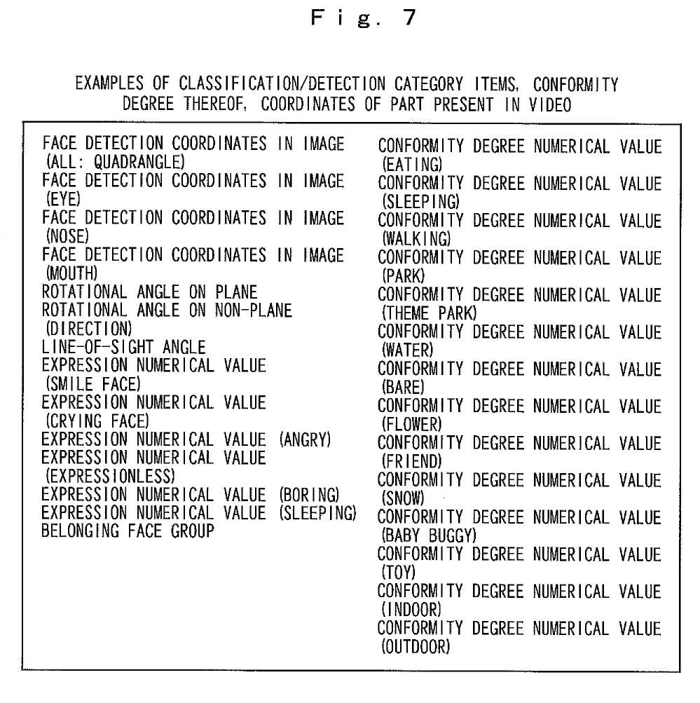

Next, the details of operations of the video feature quantity extracting unit 24, the feature quantity comparison processing unit 26, and the metadata creating unit 27 will be described with reference to the flowchart of FIG. 6. Here, a primary content is created such that metadata is assigned to a section video.

In step S1, the video feature quantity extracting unit 24 extracts the feature quantity from a section video (one in which a portion representing a feature of a video is quantified) , for example, an area, a boundary length, a degree of circularity, the center, and/or a color feature of an object such as a moving object, a face feature such as recognition or positional information of face parts, and the like. The feature quantity is not limited to a moving object and may be extracted from a stationary object or an object of a background image. As an example, the feature quantity can be extracted using a method disclosed on pages 60 to 62 of “Basic and Application of Digital Image Processing, Revised Edition” published by CQ Publishing Co., Ltd. on Mar. 15, 2007.

In step S2, the feature quantity comparison processing unit 26 compares (for example, pattern recognition) the feature quantity with information in the general database 25a of the feature quantity database 25, and acquires various classification/detection categories, a conformity degree thereof, coordinates of a part present in a video recognized according to the classification/detection category, and the like. A numerical value of the conformity degree can be set to a value between 0 and 1 by standardization. The conformity degree is calculated as a numerical value and then may be set to 1 or 0 or may be assigned a determination such as “appropriate” or “inappropriate” depending on whether or not the numerical value is larger than a predetermined threshold value.

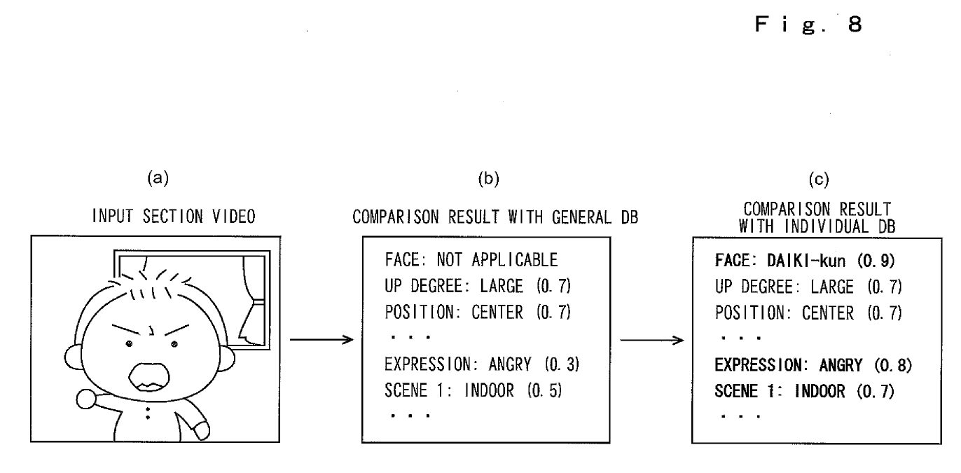

FIG. 7 illustrates an example in which the classification/detection category, the conformity degree numerical value, coordinates of a part present in a video, and the like, which are acquired in step S2, are listed. In FIG. 7, concrete values of the conformity degree numerical value, the coordinates, and the like are not presented, and only correspondence with classification/detection category items and the like is presented. As illustrated in FIG. 7, examples of the classification/detection category items include “eat”, “sleep”, “walk”, “park”, “theme park”, and the like, and the conformity degree numerical values thereof are obtained as in step S2 as described above. Among the classification/detection category items, there is also a classification/detection category item having relevance or hierarchy. For example, with respect to the classification/detection category “face”, relevant classification/detection categories can be prepared like “belonging face group” representing the identity of the face, “eye”, “nose”, “mouth”, and the like as a partial structure of the face, “smile face” , “crying face” , “surprise”, and the like as expressions of the face. A classification/detection category item clarifying what is concretely shown in a video as illustrated in FIG. 7 may be referred to particularly as a “video classification/detection item”.

As the conformity degree of the classification/detection category, for example, in the case of “face”, a numeral value of a matching degree when pattern recognition is made in comparison with the feature quantity database 25 may be used, and the conformity degree numerical value may be calculated according to a nature of each classification/detection category or a use in a secondary content . In the case of the classification./detection. category representing expression of “face” such as “smile face”, an additional item such as an expression numerical value may be particularly prepared as the conformity degree numerical value. When there is relevance between the classification/detection category items, the conformity degree may be calculated using relevance. As described above, the conformity degree and conformity degree numerical value on each classification/detection category item may be included in the classification/detection category.

Further, when the classification/detection category is “face”, coordinate information of an area where a part such as “face” is detected may be acquired in step S2. Further, a value such as positional coordinates or a line-of-sight direction may be acquired on a part such as “eye”. The positional coordinates or a line-of-sight direction may be also included in the classification/detection category.

In step S3, the feature quantity comparison processing unit compares (for example, pattern recognition) the feature quantity with information in the individual databases 25b1 to 25bn of the feature quantity database 25, and acquires various classification/detection categories, a conformity degree thereof, coordinates of a part present in a video recognized according to the classification/detection category, and the like. The process of step S3 is different from the process of step S2 in that comparison of the feature quantity is performed using the individual database rather than the general database of the feature quantity database 25. When the classification/detection category and the conformity degree are acquired by comparison with the individual database, a classification/detection category specific to an individual may be set, and a conformity degree calculating method in which an individual r s preference or the like is reflected may be set. On a classification/detection category not related to an individual, a comparison may be made only by the general data, and an item of the corresponding classification/detection category may not be set to the individual database. Thus, overlapping data or overlapping processing can be avoided in the individual database and the general database. Here, the use of the individual database is allowed using recognition information such as the user ID, and the comparison process is performed only on information of the individual database of the user who has uploaded the video (for example, when the user ID is x, comparison only with information of a corresponding individual database 25bx among the individual databases 25b1 to 25bn is made).

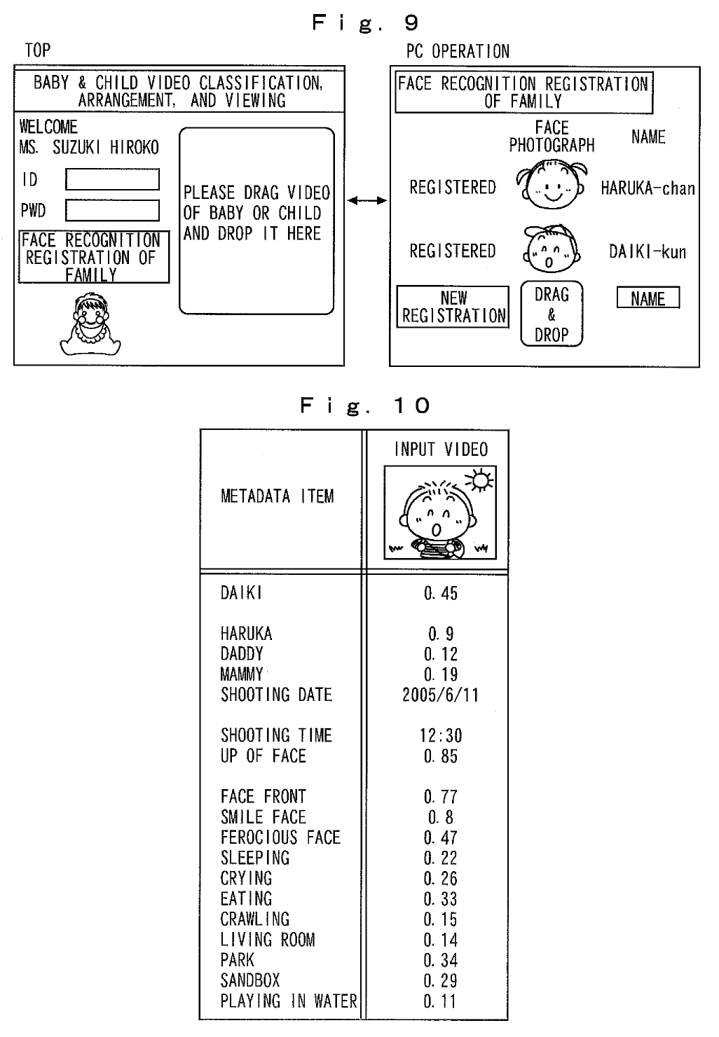

In step S4, the classification/recognition result by the general database in step S2 is compared with the classification/recognition result by the individual database in step S3, and the result of the individual database is preferentially processed. FIG. 8 is a conceptual diagram illustrating an aspect of the process in step S4. In FIG. 8, as a result of comparing an input section video (a) with the general database, a classification/detection category and conformity degree numerical value of (b) is acquired. Subsequently, a result, which is obtained by comparing with the individual database and prioritized over the result by the general database, is (c). A face has not been recognized in the general database like “not applicable”, whereas “Daiki-kun” has been recognized with a conformity degree of “0.9”. An expression numerical value of an expression “angry” has been changed from “0.3” to “0.8”, and a conformity degree numerical value of “indoor” representing a scene has been changed from “0.5” to “0.7”. Further, the same result has been obtained in “up degree” and “position” in the general database and the individual database. An item needs not be set to the individual database, and only a result of the general database is present. They have not been changed.

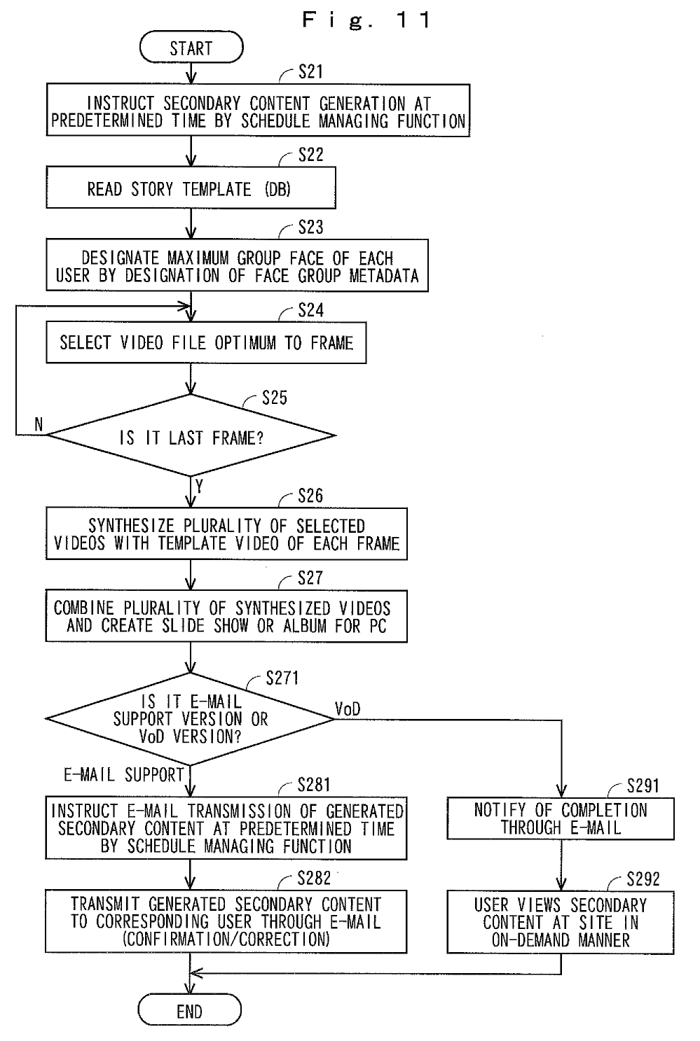

In step S4, in order to recognize a face of an individual who has a name of “Daiki-kun” that has not been recognized since there is no corresponding data in the general database illustrated in FIG. 8 through the individual database and read the name as an item of the classification/detection category, a classification/detection category “Daiki-kun” and a minimum of one scene, preferably, several scenes as a video section capturing “Daiki-kun” need to be registered to the individual database in advance. A conceptual diagram of a registration work screen is illustrated in FIG. 9 in connection with an example using a PC. The registration can be performed using the user authentication information through the imaging device 1, the terminal device 2, or the viewing device 5, and an arbitrary classification/detection category can be registered in addition to face information. As described above, through the initial registration of the user-specific classification/detection category, the user-specific classification/detection category and feature data for video recognition thereof are stored in the individual database in association with each other.

In step S5, the metadata creating unit 27 creates metadata corresponding to the section video. The metadata is created to include the user ID, section video file information including video content information (an imaging date and time, a content replay time, a file ID before and after division, a division location, a division order, and the like) before and after division, time information of a section video, a classification/detection category, each item of a classification/detection category, and a conformity degree of each item, which are acquired in steps S3 and S4, coordinate information of a relevant part, and the like.

In step S6, it is determined whether or not classification has been performed on all section videos. In case of a negative determination result, the process proceeds to step S7, and a next section video is transferred to the video feature quantity extracting unit 24. Then, the processes of steps S1 to S5 are repeated. When the process has been completed on all section videos and a positive determination result is obtained in step S6, instep S8, each section video and each corresponding metadata are stored in the primary content database 30 in association with each other as each primary content.

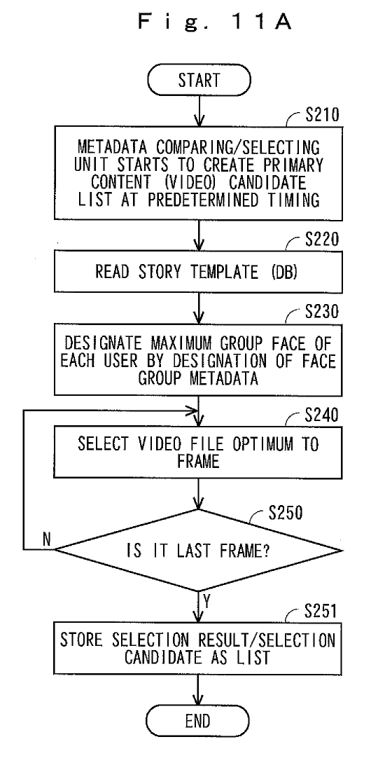

FIG. 10 illustrates a conceptual diagram of a primary content created from a section video through respective steps of FIG. 6 as described above. In FIG. 10, classification/detection categories such as “Daiki-kun”, “Haruka”, “Daddy”, “Mammy”, “up of face”, “face front”, “smile face”, . . ., and “playing in the water”, conformity degrees thereof, and a imaging date and time are associated with an input original section video as a part of metadata to form a primary content.

FIG. 6 has been described in connection with the embodiment in which the general database and the individual database are separately used as described above. In an embodiment of only the process of the general data, it is apparent that steps S3 and S4 of FIG. 6 are skipped, and step S5 is performed after step S2.

Next, a description will be made in connection with the details of an operation of creating a secondary content by performing a predetermined edit using a primary content as a material and storing the secondary content through the metadata comparing/selecting unit 31, the story template database 32, the secondary content creating unit 33, the secondary content storing unit 34, the schedule managing unit 35, and the like and delivery of the stored secondary content to the user.

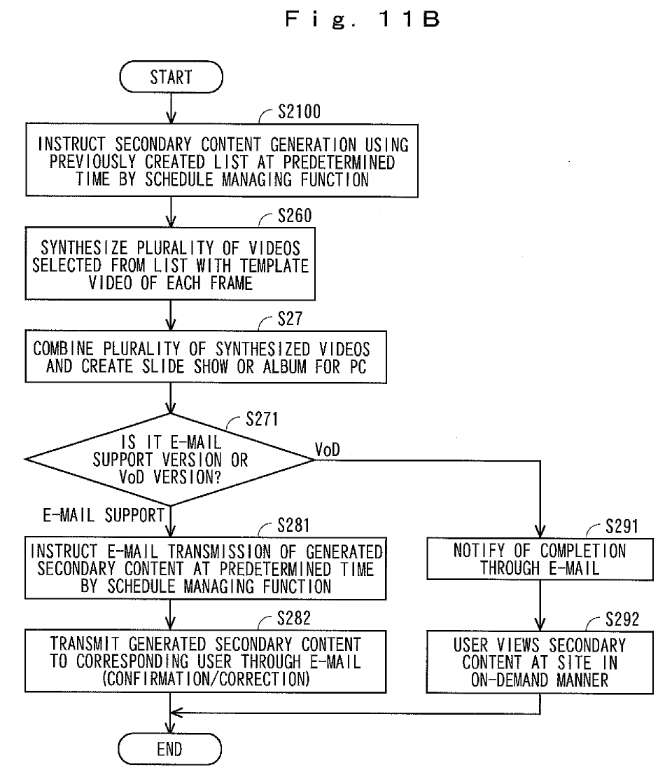

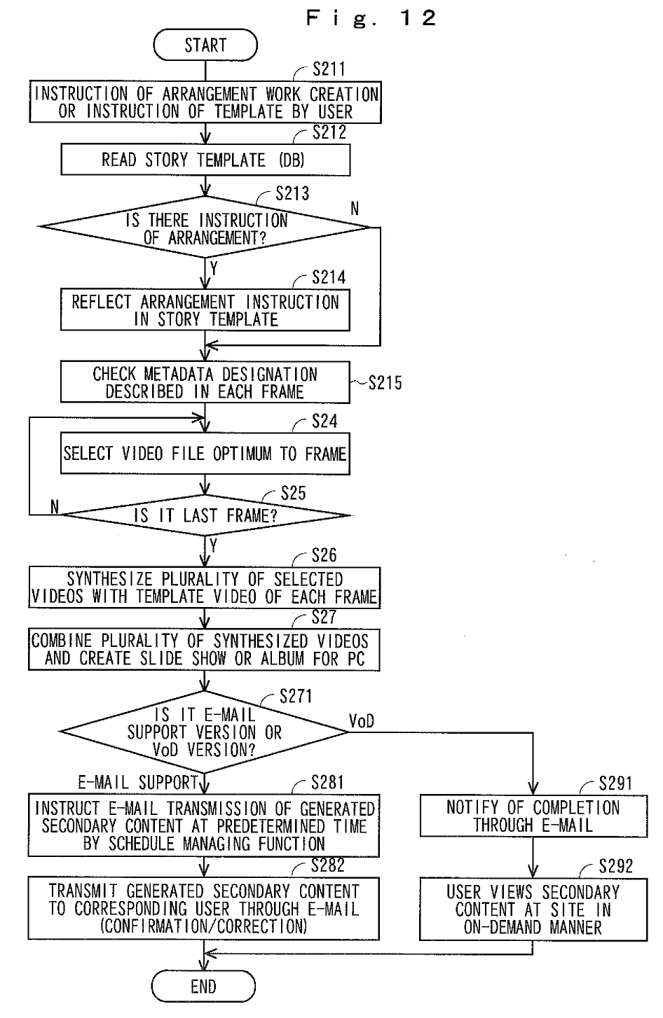

A process of creating the secondary content starts when an instruction is given by the schedule managing unit 35, when an instruction to designate a work is received from the user, and the like. First, the flow when an instruction is given by the schedule managing unit 35 will be described with reference to FIG. 11.

In step S21, the schedule managing unit 35 instructs the metadata comparing/selecting unit 31 to generate a secondary, content at a predetermined time. A time when a new story template is added to the story template database 32, a time when a predetermined number of primary contents or more are added to the primary content storing unit 30 by video content uploading by the user, and the like can be set as the predetermined time. An individual schedule may be made for each user, a schedule common to all users may be made, or a combined schedule of an individual schedule and a common schedule may be made.

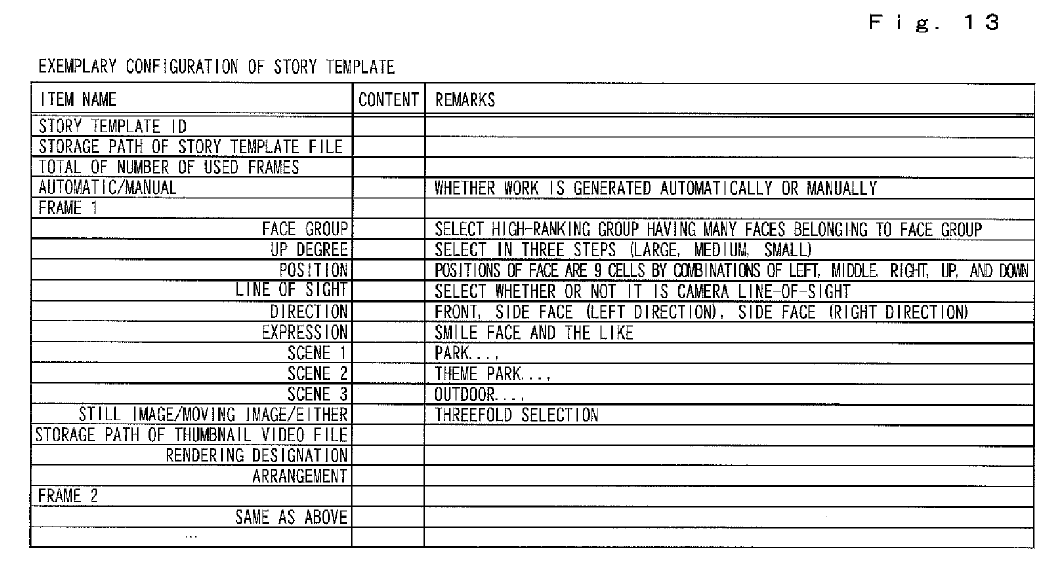

In step S22, upon receiving the instruction of the schedule managing unit 35, the metadata comparing/selecting unit 31 reads the predetermined story template from the story template database 32. The story template to be read is designated from the schedule managing unit 35 similarly to step S21. The details of the story template will be described later with reference to FIG. 13 and the like.

In step S23, when a face group, that is, a section video person associated with corresponding metadata is shown among metadata of primary contents stored and accumulated in the primary content database 30 for each user, a maximum group face in each user, that is, a face group which is the largest in number stored as the primary content is decided with reference to metadata representing who the person is. Here, a plurality of face groups are generally assigned to each primary content as metadata, but a face group which is the largest in the conformity degree numerical value of the metadata among the face groups is used as the face group of the primary content. Further, as a concrete example will be described later, since creation of a secondary content including a person who is the most in the face group as a central character is assumed, step S23 is a process supplementarily inserted to help with understanding with the process in that case. Actually, a process of a form following all instructions of the story template is performed in steps S24 and S25 which will be described below. Depending on the type of story template instructing creation of the secondary content, a plurality of high-ranking face groups, a face group corresponding to the user's family, or a face group corresponding to the user's friends may be used in step S23. Further, when there is no instruction in the story template, a face group may not be used in the process.

In step S24, as will be described later, a primary content with metadata optimum for designation of metadata described in an ordered frame configuring a story template is selected with reference to the frame, and a section video, i.e., a video file included in the primary content is selected as a material to be applied to a frame portion of the secondary content. In step S25, it is determined whether or not the process has been performed on a last frame. In case of a negative determination result, the process returns to step S24, and the process is performed on a next frame. When the process of step S24 is performed on all frames configuring the secondary content and a positive determination result is obtained in step S25, the process proceeds to step S26.

In step S26, a video in which each video file selected in step S24 is synthesized with a template video of a corresponding frame is created. That is, a video in which each video file is synthesized with a decoration video, an effect function, sound information such as a narration, and the like is created. In step S27, a plurality of synthesized videos are combined according to the instruction of the story template, and so a secondary content such as a slide show or an album for a PC is created and then stored in the secondary content storing unit 34.

In step S271, a delivery form of the secondary content is selected. When an e-mail is supported, the process proceeds to step S281. When an instruction is received at a predetermined time instructed by the schedule managing unit 35, the process proceeds to step S282, and the secondary content is transmitted to each user by e-mail in the form in which the secondary content is attached to the e-mail. After or when the e-mail is transmitted, a correction/confirmation message of secondary content is also transmitted by e-mail.

Meanwhile, when VoD delivery is determined in step S271, the process proceeds to step S291, and the fact that the secondary content is completely created is notified to the user by e-mail. When the notice is received, the process proceeds to step S292, and the user logs in the VoD viewing site and views the secondary content.

The flow of FIG. 11 has been described above. In this flow, under schedule management of the schedule managing unit 35, when an instruction to create a secondary content is given, both (1) the process of selecting a primary content and (2) the process of creating a secondary content based on the selection result and supplying with the user the secondary content have been performed. Next, another embodiment in which the processes are individually performed will be described.

In this embodiment, the primary content selecting process of the above (1) is not performed according to the instruction of the schedule managing unit 35, and instead the metadata comparing/selecting unit 31 performs the primary content selecting process at a predetermined timing in advance and stores the selection result as a list . Then, when the secondary content has been created and supplied by the schedule managing unit 35, the process of the above (2) is performed based on the selection result in the list which has been created and stored in advance.

FIG. 11A illustrates the flow of performing the primary content selecting process in advance by the metadata comparing/selecting unit 31. Step S210 starting this flow is performed at a predetermined timing, for example, each time when the user uploads a video or at predetermined intervals set by the metadata comparing/selecting unit 31. Further, the predetermined timing of step S210 may be when the content of the story template is changed, added, deleted, or the like.

Subsequently, steps S220, S230, S240, and 5250 are the same as steps S22, S23, S24, and S25 of FIG. 11. However, a processing target is limited to only a portion of a story template on which the primary content selection process needs to be newly performed.

For example, when a process for creating a new story template starts in step $210, the process is performed on the whole new story template. However, when a process for changing only a part of the existing story template starts in step S210, the process is performed on only the changed part. Further, when a process for uploading a video by the user starts in step S210, only a story template in which a primary content is likely to be used by the corresponding video becomes a processing target.

Then, in step S251, a selection result, i.e., a selection result of a best-matched primary content to be actually used in the secondary content and a selection candidate including information of a predetermined number of second-place or lower primary contents are stored as a list.

FIG. 11B illustrates the flow of creating and supplying a secondary content according to a schedule instruction by the schedule managing unit 35 based on a list which is created in advance and updated as necessary. In step S2100, the schedule managing unit 35 instructs creation of a secondary content at a predetermined timing. In step S260, the secondary content creating unit 33 performs a video synthesis with reference to the list previously created the metadata comparing/selecting unit 31 through the flow of FIG. 11A. Step S27 and subsequent steps for creating and supplying the secondary content are the same as steps including the same number in FIG. 11, and thus a description thereof will not be repeated.

The flow in which the process of creating the secondary content starts when an instruction to designate a work or the like is received from the user will be described with reference to FIG. 12.

In step S211, an instruction of arrangement work creation by changing a method of designating metadata to the user's preference using an existing story template or an instruction of an existing story template corresponding to a work desired to view without designating an arrangement of metadata particularly as a secondary content is received from an individual user. As an example of an arrangement work creation instruction, there is a case in which the user views a secondary content created by a story template in which “smile face” and “best shot” are used as main metadata used for work creation and then desires to view a secondary content created using a story template in which metadata designation is changed from “smile face” in the story template to “surprise” which is not present in an existing story template.

In step S212, the designated existing story template is read from the story template database 32. In step S213, it is determined whether or not the user has instructs an arrangement of a secondary content work by changing, adding, or deleting designated metadata. When it is determined that there is an arrangement instruction, the process proceeds to step S213, and the user instruction is reflected in a metadata designating method of each frame with respect to the read existing story template. However, when it is determined that there is no arrangement instruction, step S214 is skipped, and the existing story template is used “as is”. In step S215, checked is a metadata designating method described in each frame of a story template in which a metadata designating method is changed by the arrangement work creation instruction as described above or a story template including only an instruction of a used story template itself without changing a metadata designating method. Step S24 and subsequent steps are the same as in FIG. 11 (excluding a case where the user manually selects a video, which is described next), and thus a description thereof will not be repeated.

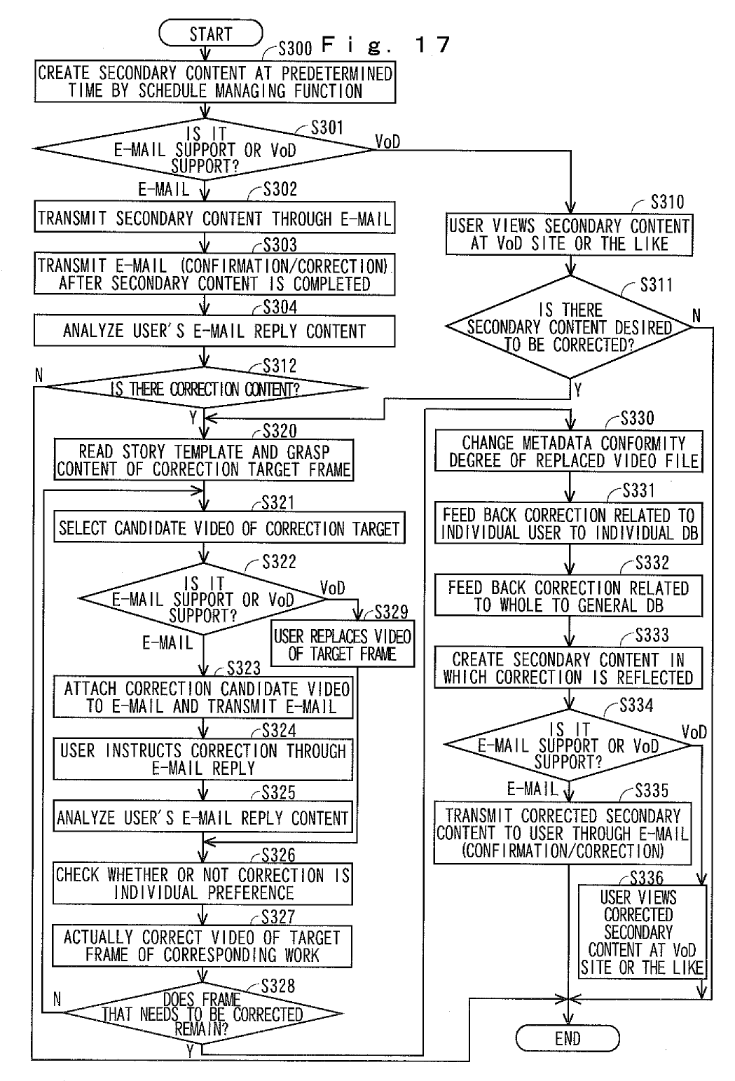

As described above , a method of allowing the user to manually select a video in step S24 may be used instead of a method of automatically processing step S24 through the metadata comparing/selecting unit 31. In this case, the metadata comparing/selecting unit 31 or the like may be caused to process metadata designation confirmed in step S215. Through a process such as step S321 in FIG. 17 which will be described later, a plurality of video candidates may be prepared by increasing an allowable range of a metadata conformity degree, and the user may manually select a desired video from among the video candidates in step S24. Further, a video may be selected directly from primary contents without being subjected to a narrowing-down process using a metadata conformity degree by a system. Even in this case, after manual selection of a video has finished on all frames and so a positive determination result is obtained in step S25, step S26 and subsequent steps are the same as in FIG. 11, and thus a description thereof will not be repeated.

Next, an example of a general configuration of a story template will be described with reference to FIG. 13. The story template includes a plurality of arrangement frames in which a video file is arranged, rendering effect on the arrangement frame, a definition related to selection from primary contents in the primary content storing unit by referring to metadata of a video file arranged in the arrangement frame, and the like.

As illustrated in FIG. 13, first as items for recognition of a story template itself, a story template with a general configuration includes a story template ID, a storage path of a story template file, that is, a primary content selection instruction file for secondary content creation and a material file such as a narration or a background image inserted as rendering information/data for secondary content creation and an additional image/character on a primary content, a total of the number of used frames, and items such as “automatic/manual” representing whether secondary content creation is automatically performed by the system or content creation is manually performed by the arrangement designation by the user.

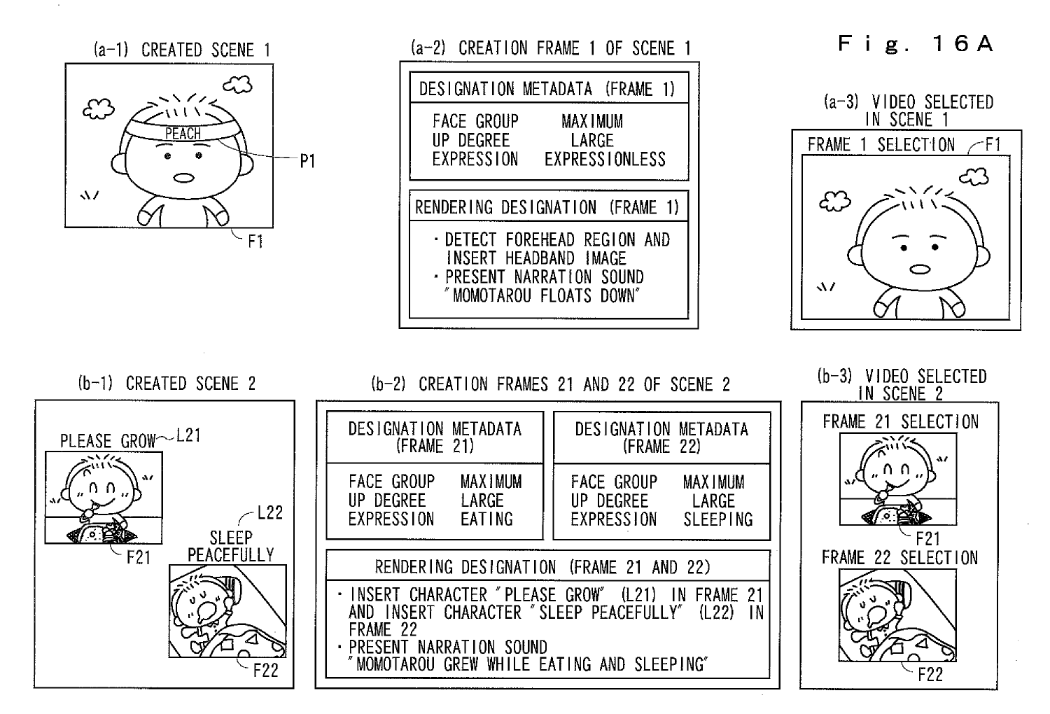

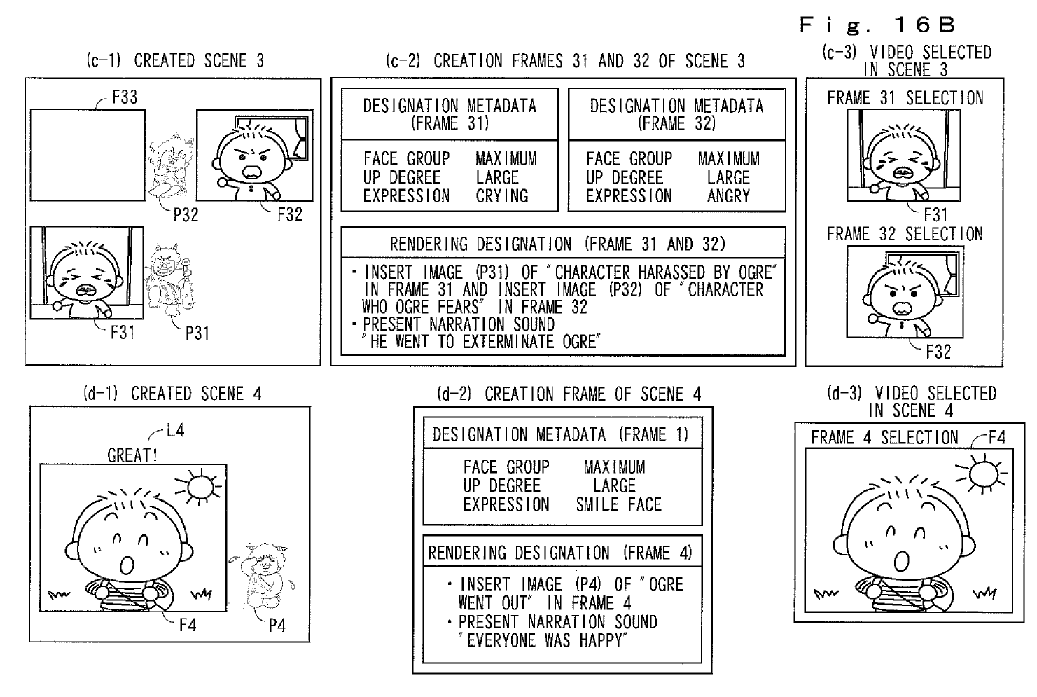

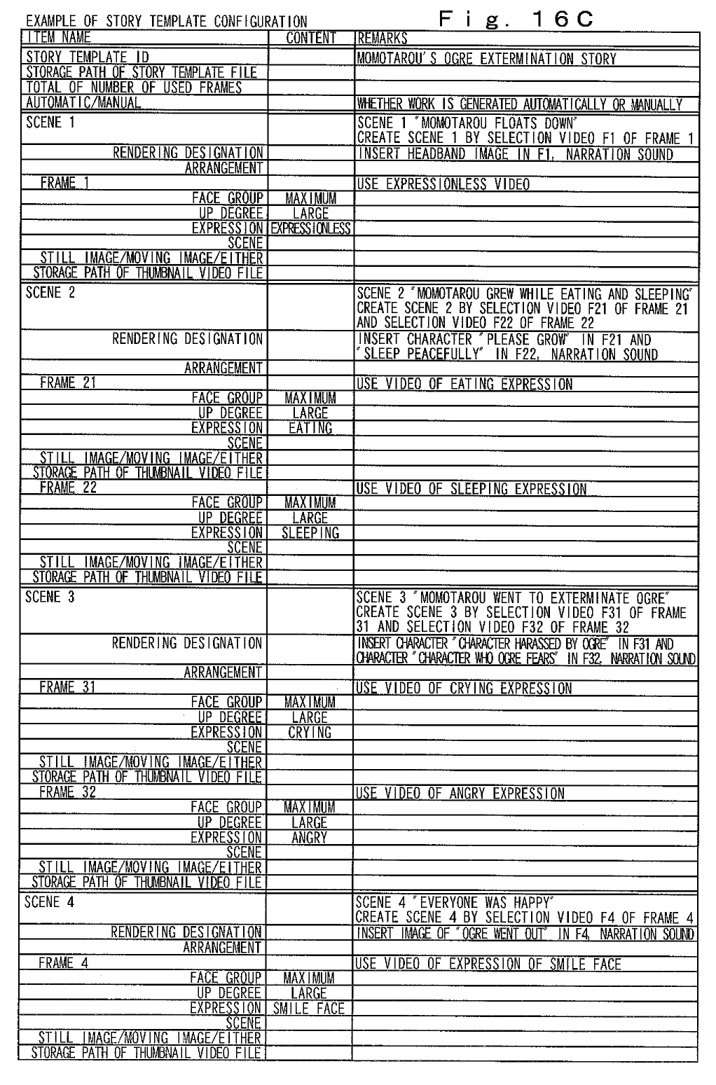

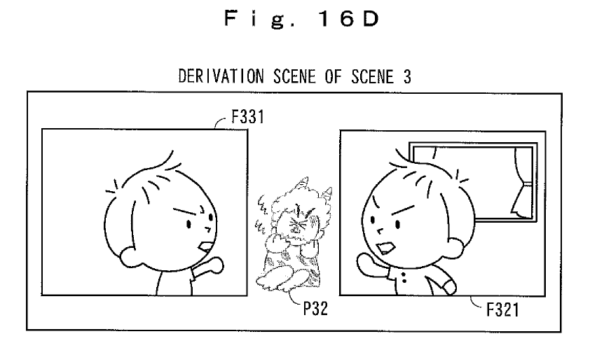

Further, specifically, included are a condition for selecting a primary content used as a part in a secondary content when a secondary content is created, and a plurality of frame items in which rendering designation of a selected primary content and an arrangement location of a selected primary content in a scene, that is, an arrangement frame are described. A rendering method, that is, a rendering effect on an arrangement frame and an arrangement will be described later with reference to FIGS. 16A and 16B. One scene can be configured in a secondary content by using one or more frames, and a secondary content to be created includes one or more relevant scenes. A rendering method and an arrangement location may be common or relevant between frames. Among frame items, as a primary content selecting condition, included are items such as “face group representing who is described as a person”, an “up degree”, a “position”, a “line of sight”, a “direction”, and an “expression”, of a face thereof, “scene 1”, “scene 2”, and “scene 3” representing a described background, and a “still image/moving image/either” related to a format of a video file as illustrated below “frame 1” in FIG. 13. The items include items common to metadata assigned to a primary content.

In FIG. 13, a “content” column is a column used to designate how to refer to and select a metadata item when a primary content is actually selected. A “remarks” column is a column used for a story template creation side to make a memorandum of how to use a metadata item when a secondary content is created.

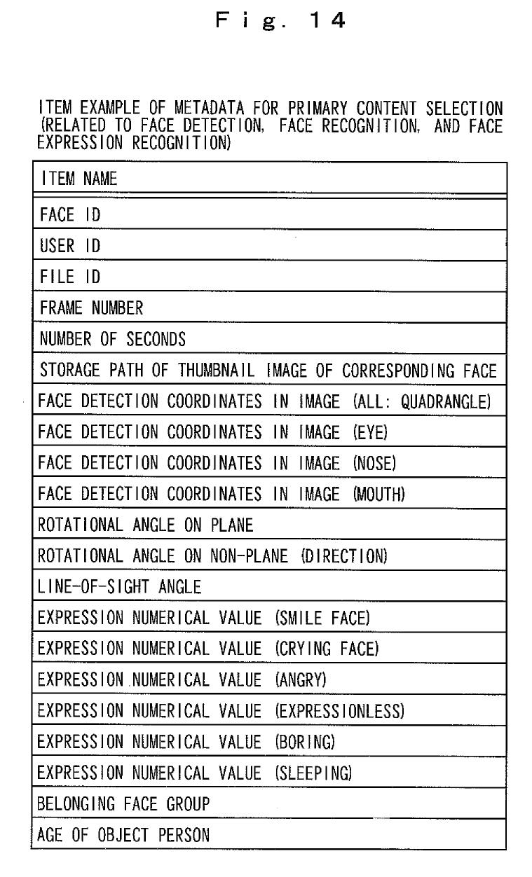

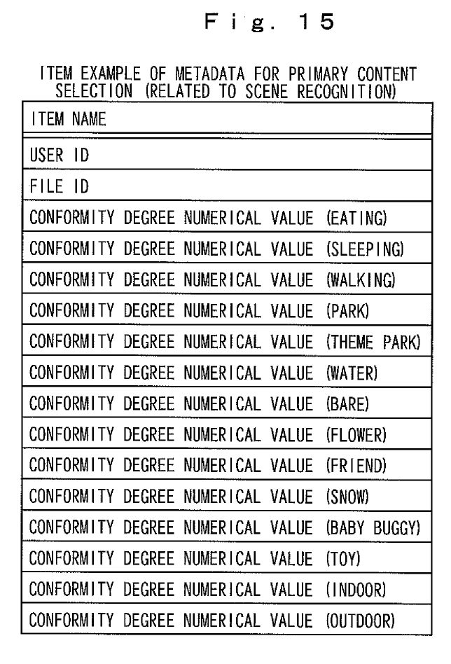

The “content” column can be designated, for example, such that “face group” which is the most in the number of primary contents is designated as in step S23 of FIG. 11 with respect to “face group”, and when “face group” designation is present in designation in an arrangement instruction by the user, it may be caused to follow the designation. Further, with respect to both items of “direction” and “expression”, designation may be made to select one which satisfies a predetermined condition. A condition for selecting one including the largest conformity degree among primary content metadata in respective items may be used as the predetermined condition. As described above, in the “content” column, a designation condition may be set to one or more items. Further, one in which designation conditions on two or more items are combined by a logical formula “AND”, “OR”, and the like may be used as a designation condition, and no designation may be made on the other conditions. For example, in items other than “face group”, a designation condition may be set with reference to metadata. As an example of a metadata item of primary content selection in each frame of a story template, examples of items which can be used in connection with face detection, face recognition, and face expression recognition are illustrated in FIG. 14, and examples of items which can be used in connection with scene recognition are illustrated in FIG. 15.

Among metadata, one which matches or deeply relates to a keyword (for example, ones related to emotional expression, expression, scene description, or the like when a material of a face is used as a theme) used in a script for creating a story or a scenario of a story template may be referred to as a “tag” in order to discriminate from one which represents only a video feature quantity among metadata.

As described above, a plurality of conditions which are relevant to each other can be designated as a metadata designation condition within one frame. However, since a story template is a template for creating a secondary content including a story using primary content video data sequentially selected by consecutive frames as a material, there is typically relevance between metadata designation conditions between consecutive frames.

As described above, an example of creating a secondary content using a story template of a format illustrated in FIG. 13 through the process of the flow illustrated in FIGS. 11, 11A, 11B, and 12 is illustrated using FIGS. 16A and 16B. The secondary content includes four scenes including a series of stories or scenarios, and is used to set a person who is a largest group face in a metadata item registered to an individual database of a certain user in a primary content of the user as a main character, select a video of the person, and create a story of Momotarou's ogre extermination story. An example of a main part of a story template which is used to create this story and has the same format as in FIG. 13 is illustrated in FIG. 16C. FIGS. 16A and 16B illustrating that a secondary content has been created through this template illustrates an example of a case in which a largest group face in a primary content of a certain user was “Daiki-kun”. Thus, in metadata designation of “face group maximum” , an example in which a video recognized as all persons are “Daiki-kun” is illustrated. In a story template example of FIG. 16C, “Daiki-kun” selected from a primary content of a certain user is a 4-years old child of the user, and a case in which the user captures images many times and primary contents corresponding to “Daiki-kun” are sufficiently present is desirable in the sense of increasing a viewing value particularly by the user of a created secondary content. The story template of FIG. 16C is an example in which secondary content viewing provision for a user storing a primary content is assumed.

A scene 1 illustrated in FIG. 16A is created according to an instruction of a frame 1 illustrated in (a-2) By searching for one which is large in conformity degree numerical values of metadata designation “face group maximum”, “up degree large”, and “expression expressionless” of the frame 1 illustrated in (a-2), a primary content having a video file F1 illustrated in (a-3) is selected from the primary content database 30. As rendering designation in the frame 1 illustrated in (a-2), that is, rendering effect on an arrangement frame, “detect a forehead area and insert a headband image P1” and “present narration sound ‘Momotarou floats down’” are added to the video file F1. Further, in (a-2) , a scene 1 illustrated in (a-1) is created by arrangement designation of the video file Fl on the whole scene screen (not illustrated) , that is, the arrangement frame.

A scene 2 illustrated in FIG. 16A is created according to instructions of two frames, that is, a frame 21 and a frame 22 illustrated in (b-2). The frames 21 and 22 cause a primary content including video files F21 and F22 illustrated in (b-3) to be selected based on metadata designation related to “face group”, “up degree”, and “expression” illustrated in (b-2). Then, the scene 2 illustrated in (b-1) is created such that through rendering designation using both the frames 21 and 22 illustrated in (b-2), a character L21 of “pleas grow” is inserted in or arranged near an selection image of the frame 21, a character L22 of “sleep peacefully” is inserted in or arranged near an selection image of the frame 22, a narration sound “Momotarou grew while eating and sleeping” is added, and arrangement designation (not illustrated) of the video file F21 on the upper left of a scene screen and arrangement designation of the video file F22 on the lower right of a scene screen are made in (b-2). Here, the video files F21 and F22 may be appropriately enlarged or reduced in the image size when they are incorporated into the scene 2 in (b-1), and designation of enlargement/reduction may be also included in rendering designation of the frames 21 and 22. Further, when the video files F21 and F22 are selected, video files extracted such that a primary content is selected by designating “up degree medium” or “up degree small” instead of designation metadata “up degree large” of (b-2) , a face area is then detected in a video file of the primary content, and only an area in the neighborhood including the face area is cut can be used as the video files F21 and F22.

A scene 3 illustrated in FIG. 16B is created according to instructions of two frames, that is, a frame 31 and a frame 32 illustrated in (c-2) The frames 31 and 32 cause a primary content including video files F31 and F32 illustrated in (c-3) to be selected based on metadata designation related to “face group”, “up degree”, and “expression” illustrated in (c-2). Then, the scene 3 illustrated in (c-1) is created such that through rendering designation using both the frames 31 and 32 illustrated in (c-2), an image P31 of “a character harassed by an ogre” is inserted in or arranged near an selection image of the frame 31, an image P32 of “a character who fears an ogre” is inserted in or arranged near an selection image of the frame 32, a narration sound “he went to exterminate an ogre” is added, and arrangement designations (not illustrated) of the video files F31 and F32 are made in (c-2). Similarly to the video files F21 and F22 of the scene 2, the video files F31 and F32 may be appropriately enlarged or reduced in the image size to the video file of the primary content or may be subjected to the face area neighborhood extracting process. Further, as a derivation of the scene 3, a scene in which the video file F33 and F32 of “Daiki-kun” surround an image P32 of “a character that an ogre fears” at the left and right and are sharply looking at the image P32 in a state of “expression angry” and a relevance of metadata between frames is efficiently utilized can be created when a selection video file by the frame 33 is arranged in F33 where only an area is illustrated in (c-1) such that “left side of the line of sight” is added to designation metadata of the frame 32, a frame including metadata designation of “face group maximum”, “up degree large”, “expression angry”, and “right side of the line of sight” is added as an additional frame 33, and an item related to the frame 33 is added to rendering designation. FIG. 16D illustrates a portion of the derivation scene changed by frame designation addition from FIG. 16 (c-1). By adding frame designation, a video that gets angry at a line of sight in, a left direction like F321 is selected instead of the video F32 of FIG. 16 (c-1), further a video F331 that gets angry at a light of sight in a right direction is selected as a portion corresponding to F33 of FIG. 16 (c-1), and the image P32 is arranged between the videos F321 and F331.

A scene 4 illustrated in FIG. 16B is created according to an instruction of a frame 4 illustrated in (d-2). The frame 4 causes a primary content including a video file F4 illustrated in (d-3) to be selected based on metadata designation related to “face group”, “up degree”, and “expression” illustrated in (d-2).

Then, the scene 4 illustrated in (d-1) is created such that by rendering designation illustrated in (d-2), a character L4 of “great!” is inserted in or arranged near the video file F4, a narration sound “everyone was happy” is added, and arrangement designation (not illustrated) in a scene screen of the video file F4 is made in (d-2).

As described above, a secondary content including a story illustrated by a narration sound in each of the scenes 1 to 4 can be created such that arrangement designation in a scene screen, that is, an arrangement frame is set to a video file of a primary content selected by metadata designation, and various rendering effects defined from various rendering designations such as addition of an decoration image such as a character or an image, addition of an effect function, addition of sound information such as a narration, and the like are executed. The narration sound can be used for rendering designation as a character for inserting and arranging the same content, and can be used as a title of each scene. Instead of the narration sound, a background music (BGM) may be added, and various rendering for increasing a viewing value of a secondary content can be carried out.

In the above description, it was assumed that the scenes 1 to 4 are clearly delimitated. However, through rendering designation, scenes can be gradually switched using a gradation effect or the like. Further, when a video file is inserted, an effect such as “slide-in/dissolve-in” may be added, and an effect such as “slide-out/dissolve-out” reversely to a video file after it is switched to a next scene may be added. In this case, particularly, in case of slide-in, when an arrangement frame is defined not as being fixed but as being movable in a scene screen, the same effect is obtained without using rendering designation. A time for increasing an effect can be set such that various effects can be synchronized with a BGM, a narration, or the like.

Further, in the above description, ones related to “face group”, “up degree”, and “expression” have been mainly described as metadata designation as an example, but a story template to which detailed designation is added can be prepared. Further, as can be seen from the example of FIGS. 16A and 16B, a secondary content with a high viewing value to the user can be automatically created in a similar manner even when a story template suitable for each imaging target is prepared by video selection by a target , which has been captured many times since the user has been interested in and attached to it, such as a vehicle, a ride, a building, a pet such as a dog or a cat, an animal, a plant, a background, a mountain, a collected thing, and a frequently captured shooting target in addition to video selection by a face group, that is, whose face. In this case, a portion or a feature corresponding to each imaging target is detected in such a way that in step S2 of FIG. 6, an eye, a nose, and a mouse which are parts of a face are detected on a face, and an expression which is a feature of a face is detected on a face, and a detected portion or feature is used in a story template as a metadata item.

Further, the above description has been made under the assumption that a primary content is selected using one which is largest in a conformity degree numerical value of a metadata item. However, the metadata comparing/selecting unit 31 may acquire information about the distribution of the conformity degree numerical values of the metadata items in the primary content database 30, and then a process for randomly selecting a primary content belonging to a high rank in the distribution may be described in a story template. In this case, even though a secondary content is created by the same template and the same primary content population, users can newly enjoy viewing the content at each time of creation. Further, when the process for randomly selecting a primary content belonging to a high rank in the distribution is applied, the process is performed to appropriately avoid that a primary content is redundantly used in the same secondary content and between the same story created twice or more using the same template, so that all primary contents belonging to high ranks in the distribution can be used without any exclusion to a secondary content.

Further, instead of creating a secondary content including a clear storyline represented by a narration sound, a secondary content including no very clear storyline can be created. For example, a secondary content including a high viewing value without a story particularly such as a smile face best shot of a person who is a maximum group face can be created using “face group” and “expression smile face” as metadata designation. In this case, preferably, prepared is a story template in which a process is performed to select primary contents including a high conformity degree numerical value randomly or in order, a predetermined number of selected smile face videos are displayed in order in each scene as a slide show or a plurality of reduced videos are simultaneously arranged as in an album for a rendering effect, and designation for adding a BGM relevant to “expression smile face” more or less or the like is included. The template can easily receive an arrangement instruction by the user's request as described with reference to FIG. 12, and a secondary content with a viewing value even after an arrangement can be generated. The arrangement instruction may be based on only an item change of “face group” and “expression”, and BGM designation or the like can be additionally instructed to the story template as necessary. Further, as an arrangement instruction by a metadata change, in addition to an arrangement by an item change of “face group” and “expression” of a metadata item described above, an arrangement instruction by addition of a metadata item, for example, addition of “line of sight, front” may be used, and further inversely an arrangement instruction for deleting a metadata item and causing a video to be selected from primary contents of a larger range may be used.

Further, creation and arrangement of a secondary content described above can be performed regardless of whether a section video of a primary content is a moving image or a still image. When a moving image and a still image are not designated particularly by metadata in a frame of a story template, a secondary content in which a moving image and a still image selected by another metadata designation in a frame are mixed is created. When designation is made by metadata of a frame, a secondary content including only a moving image or a still image can be created. Further, a secondary content to which designation of a moving image and a still image is added for each frame or for each scene can be created. In case of capable of increasing a viewing value of a secondary content by designating a moving image or a still image, it is preferable to designate a moving image or a still image to a story template. Further, at a stage at which the user uploads a video content from an imaging device or a terminal device, only one of a moving image and a still image can be used by the user's intention or an operation setting of the system.

Next, a process of correcting a secondary content by changing a primary content in use based on feed-back information from the user who viewed the secondary content and updating the primary content creating function based on the correction information will be described with reference to FIG. 17. In FIG. 17, the process will be described in connection with a case of using e-mail delivery and a case of using a VoD in connection with secondary content delivery. However, a difference between the two cases lies in only a portion related to a user interface.

First, in step S300, a secondary content is created at a predetermined time according to an instruction of the schedule managing unit 35, and then the process proceeds to step S301. In step S301, a deliver/viewing form of the secondary content is divided into a case of e-mail support and a case of VoD support. In the case of the e-mail support, the process proceeds to step S302, and the secondary content is transmitted to the user via the e-mail. Subsequently, the process proceeds to step S303, and an e-mail for urging the user to confirm and correct the transmitted secondary content is transmitted to the user as correction confirmation information. Steps S302 and S303 may be simultaneously performed such that both the secondary content and the confirmation/correction message are transmitted through the e-mail at once. Subsequently, in step S304, it is determined whether or not there is a correction content. When it is determined that there is no correction content, the process finishes, whereas when there is a correction content, the process proceeds to step S320. In the case of the VoD support in step S301, the process proceeds to step S310. In step S310, the user logs in a VoD site or the like and views a secondary content. In step S311, it is determined whether or not there is a content which the user desires to correct, that is, correction confirmation information. When there is no correction request, the process finishes, whereas when there is a correction request, the process proceeds to step S320. As described above, the process is divided into e-mail support and VoD support in step S301 but is merged in step S320 when there is a correction content.

Further, creation of a secondary content by the schedule management function in step S300 may be creation according to the embodiment described with reference to FIG. 11 or creation according to the embodiment described with reference to FIGS. 11A and 11B as described above.

In step S320, a story template for which a correction request has been received is read, and a content of a correction target frame, that is, metadata designation and a primary content selected by the designation are grasped. In step S321, a selection range by a metadata conformity degree is increased based on the grasped content, a primary content which is a correction target is searched, and a candidate video of a correction target is selected. Then, the process proceeds to step S322. In step S322, a delivery/viewing form of a secondary content is divided into a case of e-mail support and a case of VoD support. In the case of the e-mail support, the process proceeds to step S323. In step S323, a correction candidate video is converted into a thumbnail video as necessary, attached to an e-mail as a correction candidate list and correction candidate information, and then transmitted to the user. In step S324, the user gives a correction instruction through an e-mail reply. In step S325, an e-mail reply content is analyzed, and the process proceeds to step S326.

Steps S321 to S325 represents an embodiment in which a correction candidate video attached to an e-mail and provided by the system side is selected by the user. However, as another embodiment, the user may directly select a video possessed by himself/herself, and attach the possessed video to the e-mail reply, for example, in step S325 so that the uploaded video can be used.

Further, in the case of the VoD support in step S322, the process proceeds to step S329. In step S329, the user checks it as the correction candidate information through a list displaying the correction candidate videos by himself/herself at the VoD site that allows the secondary content to be viewed, and replaces a video used in a correction target frame with a user's desired video, and then the process proceeds to step S326.

Further, in the case of the VoD support, in step S329, the correction candidate video may be displayed on a site such as the user's my page. Further, instead of selecting one among correction candidate videos displayed on the site and replacing it with a desired video, the user may upload a video possessed by himself/herself the video through the site as a desired video so that the uploaded video can be used.

Here, in the relevant process of allowing the user to select a correction candidate such as steps S323 and S324 at the time of e-mail support or step S329 at the time of VoD support, an attached correction candidate video in which a designation metadata item of each frame is used as a title may be transmitted as a list, the user may use a number or the like to transmit a correction candidate through an e-mail using or to designate a correction candidate on the VoD site, and a video obtained by applying video designation to an erroneously selected video file before correction in a frame portion corresponding to a secondary content before correction may be arranged along with the correction candidate list. In this case, the user can easily image the corrected video, and so it is desirable.

In step S326, it is checked whether corresponding correction is related to the user's personal preference with respect to the correction information obtained through the process of either of the e-mail support and the VoD support. In step S327, a video which is being used after applying corresponding correction to a target frame is actually corrected. In step S328, it is determined whether or not there is a correction content of a next frame. When a frame that needs to be corrected remains, in order to perform the correction process on a next correction target frame, the process returns to step S321, and the same process is repeated.

When the correction process is performed on all frames that need to be corrected and a positive determination result is obtained in step S328, in step S330, changed is a conformity degree numerical value of a metadata item referred to by an instruction of a frame in a story template in a process in which a corresponding video file is selected as a primary content among metadata items respectively associated with all video files before and after replacement in the form of a primary content. For example, the process is performed such that a conformity degree numerical value of a corresponding metadata item in a video file before replacement is lowered by 20 percentages, and a conformity degree numerical value of a corresponding metadata item in a video file after replacement is increased by 50 percentages. When the conformity degree numerical value is in a range between 0 and 1 by standardization, if the conformity degree numerical value obtained by an increment of 50 percentages in the above process is larger than 1, the conformity degree numerical value is assumed as 1. Further, a process of reducing the difference between the conformity degree numerical value and 1 by 50 percentages or the like may be performed. When changing the conformity degree numerical value in step S330 ends, in step S331, correction related to the individual user, that is, correction related to the personal preference or the like such as expression determination in a face group individually registered by the user and a video file corresponding to the face group is fed back to the individual database of the feature quantity database 25 after authentication using the user ID or the like is performed. Here, a metadata item which is fed back to the individual database, that is, particularly an item which is high in the number of feedback times is determined as being higher in an importance degree to the user. Thus, the information is stored in the individual database, and when the conformity degree of the metadata item is decided as the feedback process on the metadata creating unit 27, a weight (for example, a value is uniformly increased by 10 percentages unlike other metadata items) in which an importance degree to the user is reflected may be added.

Next, in step S332, correction related to the whole, that is, correction on ones not related to the personal preference like a theme park or determination of a scene such as a waterfront is fed back to the general database of the feature quantity database 25. In step S333, a secondary content is created again according to primary content video file designation information on all corrected frames. In step S334, it is divided into a case of e-mail support and a case of VoD support . In the case of the e-mail support, in step S335, the corrected secondary content is transmitted to the user through the e-mail, and an e-mail of re-confirmation/re-correction on whether or not re-correction is appropriate is subsequently transmitted. In the case of the VoD support in step S334, the process proceeds to step S336, and the user views the corrected secondary content at the VoD site.

The process described with reference to FIG. 17 is mainly the feedback process to the feature quantity database 25 and the metadata creating unit 27. Meanwhile, the feedback process to the video section dividing unit 23 may be performed. In this case, in the correction request, the user may determine that the video file used in the secondary content is appropriate in the first half portion but inappropriate in the second half portion. In this case, a division location is designated, and primary content creation is performed on each of divided video files again.

In an embodiment using only the general database without using the individual database, step S326 for checking whether or not correction relates to the personal preference and step S331 of performing the feedback process to the individual DB are not provided in the flow of FIG. 17. Particularly, the feedback process is performed on the general DB in step S332.

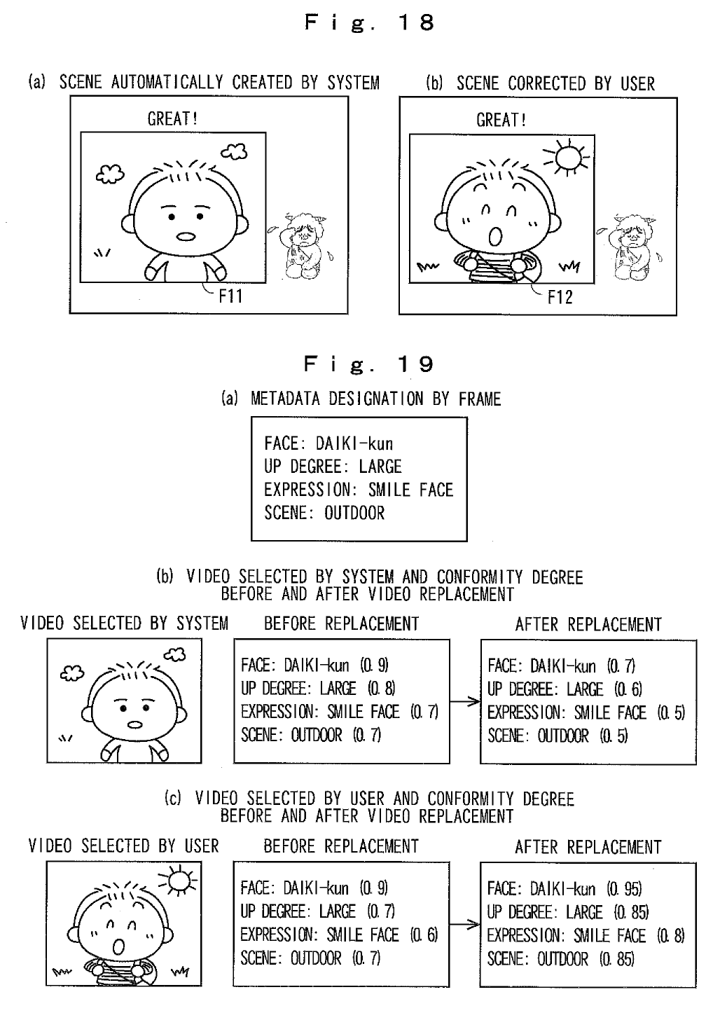

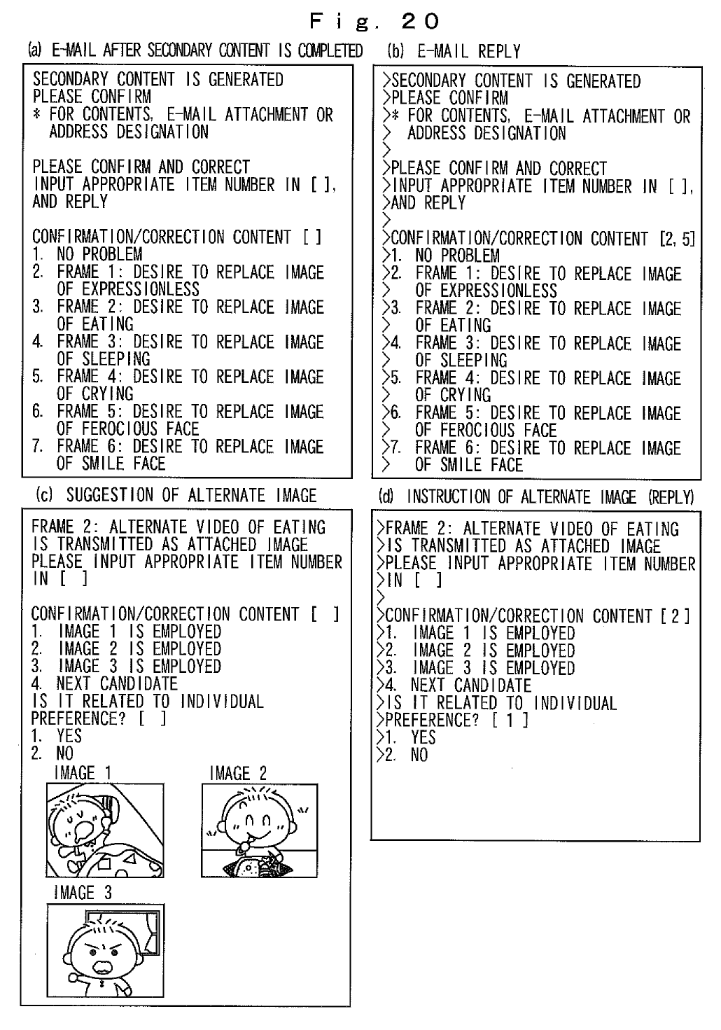

FIG. 18 illustrates an example in which a video file used in a scene automatically created by a system through the correction and feedback processes described above with reference to FIG. 17 is corrected by the user. The scene illustrated in FIG. 18 is considered as a scene created such that a video file is selected using a metadata item such as particularly “expression smile face” in a story template and an image of a character “great ” or “ogre gets frightened” which is large in rendering effect on a smile face is added as rendering designation of frame description. On the other hand, a scene automatically selected and created by the system is illustrated in FIG. 18 (a), in which the video file F11 is selected. However, the user views the scene and then determines that the used video file F11 is inappropriate in terms of a story. Then, the user is driven by a request desiring to perform correction, gives a correction instruction, and selects the video file F12. In this way, as a result of correction, a scene of FIG. 18(b) is obtained. Next, as illustrated in FIG. 19, through this correction, the system receives information representing that a video that needs to be increased in a conformity degree of “expression smile face” is F12 rather than F11 as feed-back information, and then performs the feedback process.

An example in which the metadata conformity degrees of the video files F11 (before video replacement) and F12 (after video replacement) corrected by the feedback from the user in the correction example of FIG. 18 is illustrated in FIG. 19 together with a metadata designation item for selecting a video file applied to the scene of FIG. 18 in the frame of the story template. FIG. 19 (a) illustrates a metadata designation item for selecting a video file for creating the scene of FIG. 18. FIG. 19(b) illustrates the video F11 selected by the system through the metadata designation item and a change in a metadata conformity degree before and after video replacement, in which the conformity degree is uniformly reduced by the corresponding item. FIG. 19 (c) illustrates the video file F12 which the user has selected as a replacement target and a change in a metadata conformity degree before and after video replacement, in which the conformity degree is uniformly increased by the corresponding item. When the conformity degrees before and after replacement of FIGS. 19(b) and 19(c) are compared with each other, F11 is selected by the system before video replacement, but after video replacement, since the system is supposed to select F12 rather than F11 unless a primary content having a higher conformity degree is newly added, the feedback learning process in which the user's request is reflected is performed.

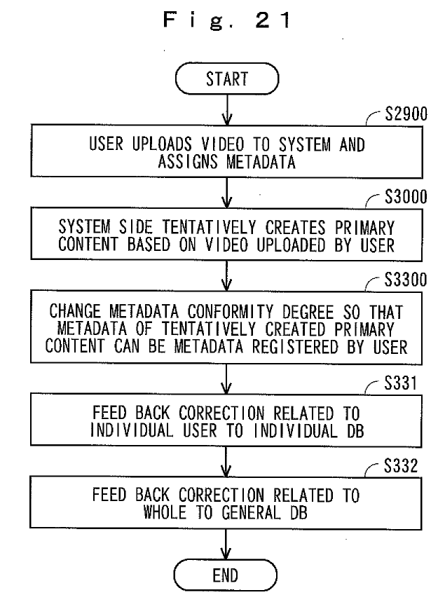

FIGS. 20(a) to 20(d) illustrate examples of an e-mail transmitted to the user side and a reply e-mail thereto in a case of e-mail support when the video file is corrected or replaced through the process of FIG. 17. FIG. 20 (a) illustrates a message example of an e-mail for confirming the presence of a correction location which is transmitted together with the secondary content after a predetermined time or when the secondary content is completed. FIG. 20 (b) illustrates an example of the user's reply e-mail to FIG. 20 (a), and as can be seen from FIG. 20 (b), the user may indicate a location desired to be corrected by designating a number such as “2,5”. Further, the correction location refers to each frame of frames 1 to 6. However, since “expressionless” to “smile face” and a metadata item are described together, the user can easily determine a scene and a video which are indicated by “frame 1: expressionless” based on a story and a scenario of the secondary content even though there is no concept of a frame configuring the secondary content. Besides “expressionless”, information clarifying an indicated scene and an indicated video may be added as necessary.

Further, FIG. 20(c) illustrates an example of an e-mail message in which the system replies a correction candidate list of a frame 2 among correction requests of frames 2 and 5 by the user's reply of FIG. 20 (b). The correction candidate video list is represented by images 1 to 3, for example, thumbnail images and also includes a query column on a personal preference. FIG. 20 (d) illustrates a reply to FIG. 20 (c). The user may indicate that the image 2 is employed by designating a number such as “2”, and may indicate that it is a change related to a personal preference by designating a number such as “1”. The system receives the corresponding correction information and corrects the individual database.

The examples of the e-mail messages transmitted and received by the user in the case of the e-mail support have been described above with reference to FIG. 20. The same exchange can be applied even to the case of the VoD support. For example, almost the same exchange as in FIG. 20 can be performed on a web site. In the case of the web site, for example, instead of “frame 1: image of expressionless is desired to be replaced” of FIG. 20 (a), actually the desire may be represented by including the frame 1 in a list as a video. Further, an alternate image in FIG. 20(c) can make indications more than the case of the e-mail, and item number selection of FIGS. 20(a) to 20 (d) may be performed through a pop-up window.

FIG. 20 illustrates the examples on an alternate replacement instruction of a video. However, a feedback process of a re-division location of a section video through an e-mail message can be performed between the user and the system in the same manner. For example, in a case of an e-mail, the user may indicate a video section desired to be re-divided by a symbol such as a number similarly to FIG. 20, and a division-desired location maybe indicated by designating a replay time or the like . Further, in a case of a Vol, actually a division location may be indicated such that a section video which is being replayed is stopped at

The process of performing feedback through correction of the secondary content supplied to the user has been described above through the flow of FIG. 17. Next, as another embodiment in which feedback is performed, when the user uploads a video (a video divided in units of section videos to which metadata can be assigned), all or some of a classification/detection categories or, more generally, metadata may be assigned. Thus, an embodiment in which feedback is performed using the assigned information will be described below.

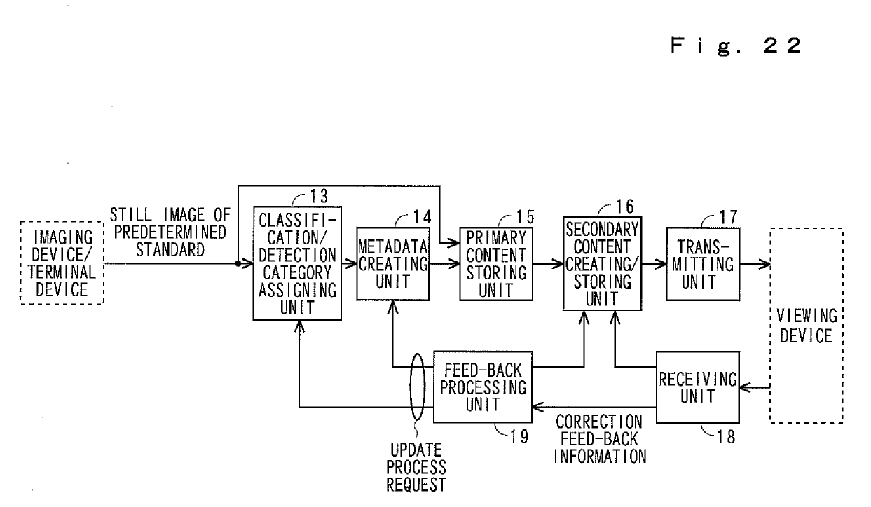

A flowchart of a feedback process according to this embodiment is illustrated in FIG. 21. First, in step S2900, the user uploads a video to the system, assigns some or all of metadata of the video, and supplies the result to the system side. The uploading corresponds to a general video input to the video input unit 4a of the platform 4 as illustrated in FIG. 1 and is accompanied with metadata assigned by the user as an additional input other than a video. As the type of an input video, for example, not a video necessary for registering each user's face information illustrated in FIG. 9 but a general video input for the user to use a service is considered.

Next, in step S3000, the system side tentatively creates a primary content from a video uploaded by the user. In other words, without referring to the metadata assigned by the user together with the video, the video feature quantity extracting unit 24, the feature quantity comparison processing unit 26, and the metadata creating unit 27 of FIG. 3 sequentially perform the process on the video and so creates a tentative primary content (a primary content in which the video is associated with metadata automatically by the present system) in the primary content DB 30.

Instep S3300, a process corresponding to step S330 of FIG. 17 is performed. In other words, as information corresponding to the feed-back information of FIG. 17, information for changing the metadata automatically assigned by the system in step S3000 to metadata assigned when the user makes video registration is transferred to the feed-back processing unit 45. Subsequent steps S331 and S332 are the same as in FIG. 17.

Further, when the metadata assigned by the user is only a metadata item, the conformity degree numerical value of the corresponding item is set to a predetermined value close to 1 and used as the feed-back information. Further, in step S332, correspondence is made as a processing content with a high importance degree.

As described above, in this embodiment, secondary content generation is not involved, but the same feedback effect as in FIG. 17 is obtained. In other words, the feature quantity DB 25 performs learning by feedback for changing metadata to a value assigned by the user, and thus a degree of accuracy is improved. Thereafter, even when the user does not assign metadata at the time of registration, metadata having a high degree of accuracy can be assigned.

An embodiment in which a video input format of the present invention is limited to a still image of a predetermined standard such as JPEG will be described. FIG. 22 is a block diagram illustrating a configuration of this embodiment. As illustrated in FIG. 22, the video recognition/secondary content creating platform 4 has a configuration in which the video standard converting unit 11, the still image/moving image determining unit 10, and the video dividing unit 12 are excluded from the configuration of FIG 2. A still image of a predetermined standard is input from the imaging device or the terminal device. Then, the still image is regarded as the video section in each embodiment, and the processes other than the process of the classification category assigning unit are the same. However, since the video dividing unit 12 is not present, the feed-back processing unit 19 requests the classification category assigning unit 13, the metadata creating unit 14, and the secondary content creating/storing unit 16 to perform the feedback process.

Further, it is obvious that even in the embodiment of FIG. 22, respective functional blocks can be implemented in the same manner as in the embodiment of FIG. 2. Particularly, for example, a camera included in the portable device 2 may be used as the imaging device 1. Further, a video may be input to the platform 4 via another system side such as a blog page or a social networking service (SNS). Further, a digital photo frame may be used as the viewing device 5.

Further, in the present invention, when the imaging device or the terminal device stores a moving image other than a still image, a still image configured with each frame of a moving image may be used as a video input in order to use this embodiment. For example, in a case of a moving image having 30 frames per second, 30 still images are generated at every second of the moving image and then input as a video. Further, by prior setting, a frame may be selected at intervals of a predetermined number of frames to generate a still image, and the generated still image may be input as a video. The embodiment of FIG. 22 may be implemented using a still image of a frame unit. Further, in the embodiment of FIG. 2, a video input may be limited to a still image of a frame unit.

According to the present invention, when the user transmits a moving image or a still image captured by himself/herself to the secondary content creating platform via the network, the system automatically assigns a user ID, a classification/detection category, and metadata including a conformity degree thereof or the like to the users video, and then stores or accumulates them as a primary content. Thus, the user needs not make an effort for inputting metadata representing the content of the captured video. Further, the system automatically creates a secondary content with a high viewing value such as a slide show or a digital album to which an illustration or a narration is added according to a story using a story template which is prepared in advance and the primary content accumulated for each user at a predetermined time or when the user's request is received, and delivers the secondary content through an e-mail or a VoD. Thus, the user can enjoy viewing various secondary contents only by storing the captured video. Further, when the system erroneously assigns metadata or assigns metadata inappropriate to the user's preference, a primary content inappropriate to a story is being used in a secondary content viewed by the user. However, the user can determine that the used primary content is inappropriate, receive video candidates of a replacement target and an alternate target from his/her primary contents, transmit a replacement instruction to perform correction, and thus view the corrected secondary content again.

Further, the system corrects and updates a dictionary function in which metadata is assigned to a primary content and causes the dictionary function to be learned by using correction information from the user, and so a degree of accuracy of assigning metadata to a primary content is improved. As a result, when a video is selected for creation of a secondary content, selection in which the user's intent is more reflected is made, and a secondary content that is high in the satisfaction level of the user is likely to be created. In other words, through feedback, when a video similar to a video in which feedback has been performed is input later, a possibility that metadata fed back by the user or data close to the metadata will be first assigned is high.

Further, since the correction is an active request on an improvement of a secondary content with a viewing value, the user's desire for performing a correction work is promoted. Further, the correction work is performed only by selecting a material video used in the secondary content from the correction replacement candidate list, and so there is no burden such as a complicated metadata edit. The correction work can be used for a learning update of a dictionary function of a metadata assignment which consequently becomes a very complicated work if it is performed directly by a manual work. Further, since the dictionary function includes an individual database prepared for each user, an individual recognition function necessary only for a certain user is enhanced and learned based on feed-back information of only the certain user, and there is no bad influence on a recognition function necessary for other users. Further, in a dictionary function used commonly regardless of a user, since a database common to users is prepared, a commonly required recognition function is efficiently enhanced and learned by feedbacks of many users.

### REFERENCE SIGNS LIST

11, 22: video standard converting unit

12: video dividing unit

23: video section dividing unit

13: classification/detection category assigning unit

14, 27: metadata creating unit

15: primary content storing unit

30: primary content database

16, 33: secondary content creating unit

17: transmitting unit

19, 45: feed-back processing unit

24: video feature quantity extracting unit

25: feature quantity database

26: feature quantity comparison processing unit

33: secondary content creating unit

32: story template database

1. A secondary content provision system, comprising:
a video standard converting unit that converts a video content including a still image uploaded via a network into a video section of a predetermined video standard;
a classification/detection category assigning unit that automatically assigns a classification/detection category to said video section converted by said video standard converting unit;
a metadata creating unit that creates metadata including said classification/detection category;
a primary content storing unit that stores a video file of said video section in association with said metadata as a primary content;
a secondary content creating unit that automatically creates a secondary content by selecting said video file associated with said metadata from said primary content storing unit based on said metadata and adding a predetermined edit to said selected video file;
a transmitting unit that transmits said secondary content and correction candidate information related to said secondary content; and
a feed-back processing unit that receives and processes correction feed-back information related to said secondary content,
wherein said feed-back processing unit requests at least one of said classification/detection category assigning unit and said metadata creating unit to perform an update process according to content of said correction feed-back information.

2. A secondary content provision system, comprising:
a video standard converting unit that converts a video content uploaded via a network into a predetermined video standard;
a video dividing unit that divides said video content converted by said video standard converting unit into a plurality of video sections having a relevant content as one video section;
a classification/detection category assigning unit that automatically assigns a classification/detection category to said video section divided by said dividing unit;
a metadata creating unit that creates metadata including said classification/detection category;
a primary content storing unit that stores a video file of said video section in association with said metadata as a primary content;
a secondary content creating unit that automatically creates a secondary content by selecting said video file associated with said metadata from said primary content storing unit based on said metadata and adding a predetermined edit to said selected video file;
a transmitting unit that transmits said secondary content and correction candidate information related to said secondary content; and
a feed-back processing unit that receives and processes said correction feed-back information related to said secondary content,
wherein said feed-back processing unit requests at least one of said video dividing unit, said classification/detection category assigning unit, and said metadata creating unit to perform an update process according to content of said correction feed-back information.

3. A secondary content provision system, comprising:
a classification/detection category assigning unit that uses a still image of a predetermined standard as a video section and automatically assigns a classification/detection category to said video section;
a metadata creating unit that creates metadata including said classification/detection category;
a primary content storing unit that stores a video file of said video section in association with said metadata as a primary content;
a secondary content creating unit that automatically creates a secondary content by selecting said video file associated with said metadata from said primary content storing unit based on said metadata and adding a predetermined edit to said selected video file;
a transmitting unit that transmits said secondary content and correction candidate information related to said secondary content; and
a feed-back processing unit that receives and processes said correction feed-back information related to said secondary content,
wherein said feed-back processing unit requests at least one of said classification/detection category assigning unit and said metadata creating unit to perform an update process according to content of said correction feed-back information.

4. The secondary content provision system according to claim 3, wherein said classification/detection category assigning unit includes a video feature quantity extracting unit that extracts a video feature quantity of said video section, a feature quantity database that stores an association between said video feature quantity and a video classification/detection items including a plurality of items, and a feature quantity comparison processing unit that compares said video feature quantity with said feature quantity database and decides a conformity degree of said video classification/detection item, and
said classification/detection category includes said video classification/detection item and said conformity degree belonging to said video classification/detection item.

5. The secondary content provision system according to claim 4, wherein said feature quantity database includes a general database generally used regardless of a user ID included in said video section and an individual database used to be specific to said user ID when used by a comparison with said video feature quantity and when used by an update process by said feed-back processing unit, and
said feature quantity comparison processing unit prioritizes a comparison result with said individual database over a comparison result with said general database.

6. The secondary content provision system according to claim 4, wherein said secondary content creating unit includes a story template database that stores a story template including a plurality of arrangement frames for arranging said video file, a rendering effect on said arrangement frame, and a definition related to selection from among primary contents in said primary content storing unit with reference to said metadata of said video file arranged on said arrangement frame, and
said secondary content is created according to said story template in said story template database.

7. The secondary content provision system according to claim 6, wherein said video classification/detection category assigned by said classification/detection category assigning unit includes a face group representing a person having a face shown in said video section and a conformity degree of said face group, and said story template database includes a story template in which said definition to said selection includes a selection determination criterion on whether or not a conformity degree of a predetermined face group satisfies a predetermined criterion.

8. The secondary content provision system according to claim 6, wherein said video classification/detection category assigned by said classification/detection category assigning unit includes an expression item representing an expression of a face shown in said video section and a conformity degree of said expression item, and said story template database includes a story template in which said definition to said selection includes a selection determination criterion on whether or not a conformity degree of a predetermined expression item satisfies a predetermined criterion.

9. The secondary content provision system according to claim 6, wherein said secondary content creating unit creates a correction replacement candidate list of said video file selected and arranged in said secondary content as said correction candidate information with reference to said story template, and said correction feed-back information includes information for deciding a correction candidate from said correction replacement candidate list.

10. The secondary content provision system according to claim 6, wherein said feed-back processing unit reads metadata of a pre-corrected primary content and a post-corrected primary content and said definition related to said selection of a correction location in said story template from said correction feed-back information, and causes said secondary content creating unit to perform an update process so that said post-corrected primary content is selected with priority over said pre-corrected primary content according to said definition related to said selection.

11. The secondary content provision system according to claim 6, wherein said correction feed-back information related to said secondary content includes designation information of metadata in said story template, and
said story template receives metadata designation information of said correction feed-back information and changes designation information of metadata in said story template.

12. The secondary content provision system according to claim 6, wherein transmission by said transmitting unit and reception of feed-back information by said feed-back processing unit are performed by either an e-mail or a VoD.

13. A method of providing a secondary content, comprising:
a video standard converting process of converting a video content including a still image uploaded via a network into a video section of a predetermined video standard;
a classification/detection category assigning process of automatically assigning a classification/detection category to said video section converted by said video standard converting process;
a metadata creating process of creating metadata including said classification/detection category;
a primary content storing process of storing a video file of said video section in association with said metadata as a primary content;
a secondary content creating process of automatically creating a secondary content by selecting said video file associated with said metadata from said primary content storing process based on said metadata and adding a predetermined edit to said selected video file;
a transmitting process of transmitting said secondary content and correction candidate information related to said secondary content; and
a feed-back processing process of receiving and processing said correction feed-back information related to said secondary content,
wherein said feed-back processing process requests at least one of said classification/detection category assigning process and said metadata creating process to perform an update process according to content of said correction feed-back information.

14. A method of providing a secondary content, comprising:
a video standard converting process of converting a video content uploaded via a network into a predetermined video standard;
a video dividing process of dividing said video content converted by said video standard converting process into a plurality of video sections having a relevant content as one video section;
a classification/detection category assigning process of automatically assigning a classification/detection category to said video section divided by said video dividing process;
a metadata creating process of creating metadata including said classification/detection category;
a primary content storing process of storing a video file of said video section in association with said metadata as a primary content;
a secondary content creating process of automatically creating a secondary content by selecting said video file associated with said metadata from said primary content storing process based on said metadata and adding a predetermined edit to said selected video file;
a transmitting process of transmitting said secondary content and correction candidate information related to said secondary content; and
a feed-back processing process of receiving and processing said correction feed-back information related to said secondary content,
wherein said feed-back processing process requests at least one of said video dividing process, said classification/detection category assigning process, and said metadata creating process to perform an update process according to content of said correction feed-back information.
